(19) United States
(12) Patent Application Publication
(10) Pub. No.: US 2025/0172806 A1
(43) Pub. Date: May 29, 2025

(54) WEARABLE DEVICE FOR CHANGING FRAME RATE ASSOCIATED WITH FOVEATED RENDERING ACCORDING TO MOVEMENT SPEED OF GAZE POSITION AND METHOD THEREOF

(71) Applicant: Samsung Electronics Co., Ltd., Suwon-si (KR)

(72) Inventors: Sungoh KIM, Suwon-si (KR); Jaeyun SONG, Suwon-si (KR); Donghyun YEOM, Suwon-si (KR); Kihwan KIM, Suwon-si (KR)

(21) Appl. No.: 18/918,619

(22) Filed: Oct. 17, 2024

Related U.S. Application Data
(63) Continuation of application No. PCT/KR2024/014031, filed on Sep. 13, 2024.

(30) Foreign Application Priority Data
Nov. 23, 2023 (KR) 10-2023-0164936
Feb. 20, 2024 (KR) 10-2024-0024292
Apr. 17, 2024 (KR) 10-2024-0051546

(51) Int. Cl. G02B 27/01; G06F 3/01; G06T 15/20

(52) U.S. Cl. CPC G02B 27/0172; G06F 3/013; G06T 15/20

(57) ABSTRACT

According to an embodiment, a wearable device obtains information with respect to a gaze position by using at least one sensor. The wearable device, based on identifying a movement speed of the gaze position slower than a reference speed using the information, obtains a plurality of first images corresponding to a display area of the display system. The wearable device obtains a second image corresponding to a foveated area that is specified within the display area based on the gaze position. The wearable device performs foveated rendering with respect to a screen to be displayed through the display area by combining the second image to each of the plurality of first images that is upscaled based on a size of the display area.

### CROSS-REFERENCE TO RELATED APPLICATION(S)

This application is a continuation application, claiming priority under § 365 (c), of an International application No. PCT/KR2024/014031, filed on Sep. 13, 2024, which is based on and claims the benefit of a Korean patent application number 10-2023-0164936, filed on Nov. 23, 2023, in the Korean Intellectual Property Office, of a Korean patent application number 10-2024-0024292, filed on Feb. 20, 2024, in the Korean Intellectual Property Office, and of a Korean patent application number 10-2024-0051546, filed on Apr. 17, 2024, in the Korean Intellectual Property Office, the disclosure of each of which is incorporated by reference herein in its entirety.

### BACKGROUND

### 1. Field

The disclosure relates to a wearable device for changing a frame rate associated with foveated rendering according to a movement speed of a gaze position and a method thereof.

### 2. Description of Related Art

In order to provide an enhanced user experience, an electronic device that provide an augmented reality (AR) service that display information generated by a computer in association with an external object in the real-world are being developed. The electronic device may be a wearable device that may be worn by a user. For example, the electronic device may be AR glasses and/or a head-mounted device (HMD).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable device for changing a frame rate associated with foveated rendering according to a movement speed of a gaze position and a method thereof.

Additional aspects will be set forth in part in the description which follows and, in part, will be apparent from the description, or may be learned by practice of the presented embodiments.

In accordance with an aspect of the disclosure, a wearable device is provided. The wearable device may comprise a display system including a first display and a second display which are configured to be respectively positioned toward eyes of a user wearing the wearable device, at least one sensor, memory storing one or more computer programs, and one or more processors communicatively coupled to the display, the at least one sensor, and the memory. The one or more computer programs include computer-executable instructions that, when executed by the one or more processors individually or collectively, cause the wearable device to obtain information with respect to a gaze position by using the at least one sensor. The one or more computer programs include computer-executable instructions that, when executed by the one or more processors individually or collectively, cause the wearable device to, based on identifying a movement speed of the gaze position slower than a reference speed using the information, obtain a plurality of first images corresponding to a display area of the display system. The one or more computer programs include computer-executable instructions that, when executed by the one or more processors individually or collectively, cause the wearable device to, obtain a second image corresponding to a foveated area that is specified within the display area based on the gaze position. The one or more computer programs include computer-executable instructions that, when executed by the one or more processors individually or collectively, cause the wearable device to, perform foveated rendering with respect to a screen to be displayed through the display area by combining the second image to each of the plurality of first images that is upscaled based on a size of the display area.

In accordance with another aspect of the disclosure, a method of a wearable device including a display system including a first display and a second display which are configured to be respectively positioned toward eyes of a user wearing the wearable device and at least one sensor is provided. The method may include obtaining information with respect to a gaze position by using the at least one sensor. The method may include, based on identifying a movement speed of the gaze position slower than a reference speed using the information, obtaining a plurality of first images corresponding to a display area of the display system. The method may include obtaining a second image corresponding to a foveated area that is specified within the display area based on the gaze position The method may include performing foveated rendering with respect to a screen to be displayed through the display area by combining the second image to each of the plurality of first images that is upscaled based on a size of the display area.

According to an embodiment, a wearable device may comprise at least one display, at least one sensor, at least one processor comprising processing circuitry, and memory comprising one or more storage mediums, storing instructions. The instructions, when executed by the at least one processor individually and/or collectively, may cause the wearable device to display an image in the entire display area of the at least one display according to the first frame rate while identifying the movement speed of the gaze position higher than the first reference speed through the at least one sensor. The instructions, when executed by the at least one processor individually and/or collectively, may cause the wearable device to display an image in a foveated portion of the display area according to a second frame rate lower than the first frame rate, and display an image in a periphery portion of the display area, while identifying the movement speed of the gaze position lower than the first reference speed and higher than the second reference speed through the at least one sensor. The instructions, when executed by the at least one processor individually and/or collectively, may cause the wearable device to display an image in the foveated portion according to a third frame rate lower than the second frame rate, and display an image in the periphery portion according to the second frame rate, while identifying the movement speed of the gaze position lower than the second reference speed through the at least one sensor.

In an embodiment, a method of a wearable device comprising at least one display and at least one sensor may be provided. The method may comprise displaying an image in the entire display area of the at least one display according to the first frame rate while identifying the movement speed of the gaze position higher than the first reference speed through the at least one sensor. The method may comprise displaying an image in a foveated portion of the display area according to a second frame rate lower than the first frame rate, and displaying an image in a periphery portion of the display area, while identifying the movement speed of the gaze position lower than the first reference speed and higher than the second reference speed through the at least one sensor. The method may comprise displaying an image in the foveated portion according to a third frame rate lower than the second frame rate, and displaying an image in the periphery portion according to the second frame rate, while identifying the movement speed of the gaze position lower than the second reference speed through the at least one sensor.

In an embodiment, a non-transitory computer readable storage medium comprising instructions may be provided. The instructions, when executed by a wearable device comprising a display system including a first display and a second display which are configured to be positioned toward each of eyes of a user wearing the wearable device and at least one sensor, may cause the wearable device to, while identifying a movement speed of a gaze position higher than a reference speed through the at least one sensor, control the display system to respectively display images obtained according to a first frame rate in foveated portion and a periphery portion. The instructions, when executed by a wearable device, may cause the wearable device to, while identifying a movement speed of the gaze position lower than the reference speed through the at least one sensor, control the display system such that an image obtained according to the first frame rate is displayed in the periphery portion and an image obtained according to a second frame rate lower than the first frame rate is displayed in the foveated portion.

According to an embodiment, a wearable device may comprise a display system including a first display and a second display which are configured to be positioned toward each of eyes of a user wearing the wearable device, at least one sensor, at least one processor comprising processing circuitry, and memory, comprising one or more storage mediums, storing instructions. The instructions, when executed by the at least one processor individually and/or collectively, may cause the wearable device to, while identifying a movement speed of a gaze position higher than a reference speed through the at least one sensor, control the display system to respectively display images obtained according to a first frame rate in foveated portion and a periphery portion. The instructions, when executed by the at least one processor individually and/or collectively, may cause the wearable device to, while identifying a movement speed of the gaze position lower than the reference speed through the at least one sensor, control the display system such that an image obtained according to the first frame rate is displayed in the periphery portion and an image obtained according to a second frame rate lower than the first frame rate is displayed in the foveated portion.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an embodiment of a wearable device that performs foveated rendering according to an embodiment of the disclosure;

FIGS. 2A and 2B illustrate block diagrams of a wearable device according to various embodiments of the disclosure;

FIGS. 3A and 3B illustrate flowcharts of a wearable device according to various embodiments of the disclosure;

FIG. 4 illustrates an operation of a wearable device that determines information with respect to a gaze position according to an embodiment of the disclosure;

FIG. 5 illustrates an operation of a wearable device that determines a frame rate according to a movement speed of a gaze position according to an embodiment of the disclosure;

FIGS. 6A and 6B illustrate flowcharts for an operation of a wearable device related to foveated rendering according to various embodiments of the disclosure;

FIGS. 7A and 7B illustrate flowcharts for an operation of a wearable device that detected a gaze position moving at a movement speed in a first speed range of FIG. 5 according to various embodiments of the disclosure;

FIGS. 8A and 8B illustrate flowcharts for an operation of a wearable device that detected a gaze position moving at a movement speed in a third speed range of FIG. 5 according to various embodiments of the disclosure;

FIGS. 9A and 9B illustrate flowcharts for an operation of a wearable device that detected a gaze position moving at a movement speed in a second speed range of FIG. 5 according to various embodiments of the disclosure; and

FIGS. 10A and 10B illustrate an exterior of a wearable device according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the document, an expression, such as “A or B”, “at least one of A and/or B”, “A, B or C”, or “at least one of A, B and/or C”, and the like may include all possible combinations of items listed together. Expressions, such as “1st”, “2nd”, “first” or “second”, and the like may modify the corresponding components regardless of order or importance, is only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the document may include a unit configured with hardware, software, or firmware, and may be used interchangeably with terms, such as logic, logic block, component, or circuit, and the like, for example. The module may be an integrally configured component or a minimum unit or part thereof that performs one or more functions. For example, a module may be configured with an application-specific integrated circuit (ASIC).

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

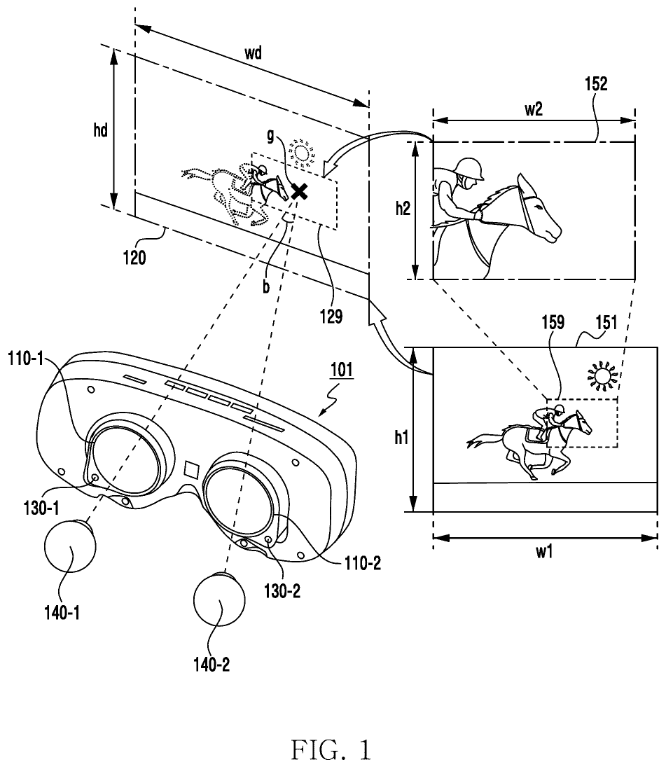

FIG. 1 illustrates an embodiment of a wearable device that performs foveated rendering according to an embodiment of the disclosure.

Referring to FIG. 1, a wearable device 101 may include a head-mounted display (HMD) that is wearable on a user's head. The wearable device 101 may be referred to as a head-mount display (HMD) device, a headgear electronic device, a glasses-type (or goggle-type) electronic device, a video see-through or visible see-through (VST) device, an extended reality (XR) device, a virtual reality (VR) device, and/or an augmented reality (AR) device.

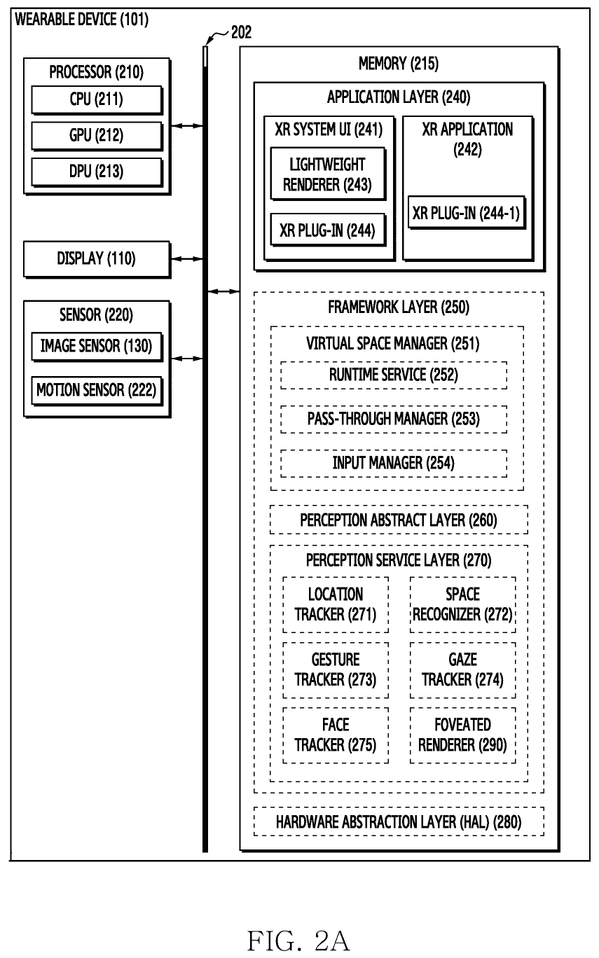

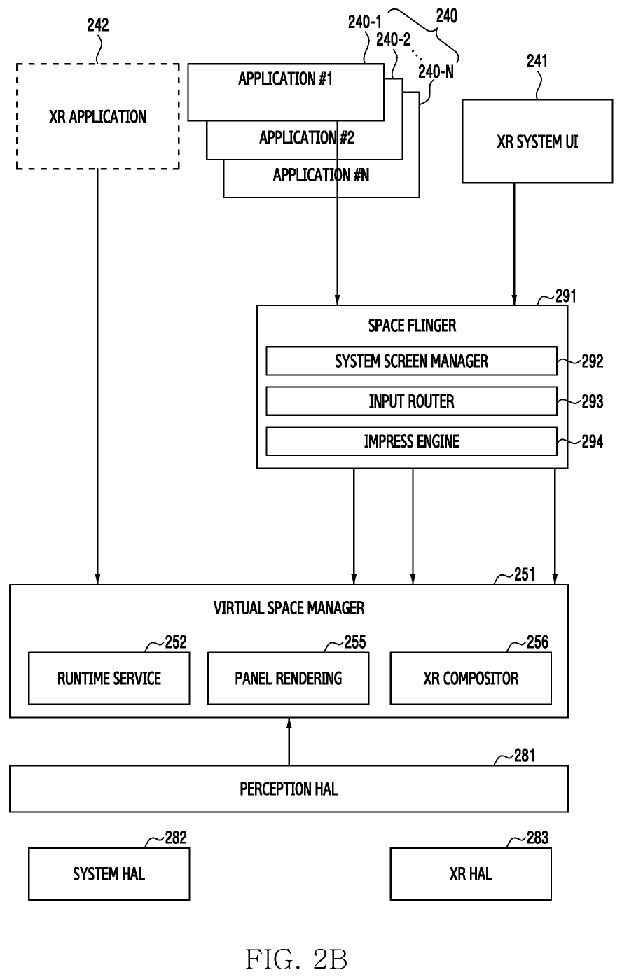

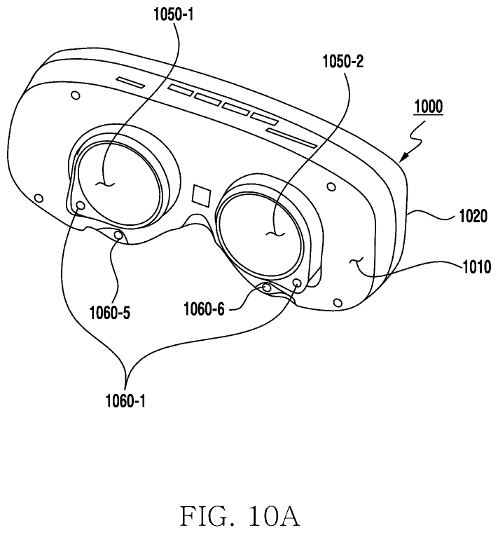

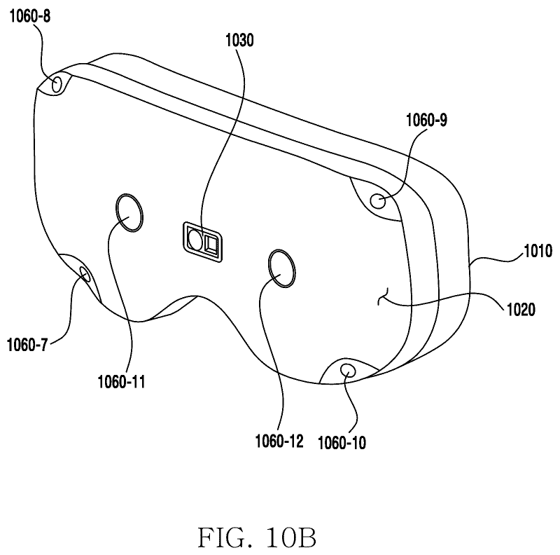

The wearable device 101 designed to block external light directed to the user's eyes while being worn on the user's head is illustrated, but the embodiment is not limited thereto. An example of a hardware configuration included in the wearable device 101 is exemplarily described with reference to FIG. 2A. An example of a structure of the wearable device 101 that is wearable on the user's head is described with reference to FIGS. 10A and/or 10B. The wearable device 101 may be referred to as an electronic device. For example, the electronic device may include an accessory (e.g., a strap) for being attached to the user's head.

According to an embodiment of the disclosure, the wearable device 101 may execute a function related to augmented reality (AR) and/or mixed reality (MR). For example, in a state in which the user wears the wearable device 101, the wearable device 101 may include at least one lens disposed adjacent to the user's eye. The wearable device 101 may combine light emitted from a display of the wearable device 101 with ambient light passing through a lens. A display area of the display may be formed in the lens through which the ambient light passes. Since the wearable device 101 combines the ambient light and the light emitted from the display, the user may see a mixed image of a real object recognized by the ambient light and a virtual object formed by the light emitted from the display. The augmented reality, mixed reality, and/or virtual reality described above may be referred to as extended reality (XR).

According to an embodiment of the disclosure, the wearable device 101 may execute a function related to video see-through or visible see-through (VST) and/or virtual reality (VR). For example, in the state in which the user wears the wearable device 101, the wearable device 101 may include a housing covering the user's eyes. The wearable device 101 may include a display disposed on a first surface of the housing facing the eye, in the state. Referring to FIG. 1, the wearable device 101 may include a first display 110-1 configured to face a left eye 140-1 of the user wearing the wearable device 101 and a second display 110-2 configured to face a right eye 140-2 of the user wearing the wearable device 101.

According to an embodiment of the disclosure, the wearable device 101 may include at least one image sensor configured to be arranged toward the user's eyes. Referring to FIG. 1, the wearable device 101 may include a first eye tracking camera (ET CAM) 130-1 configured to face the left eye 140-1 of the user wearing the wearable device 101 and a second eye tracking camera 130-2 configured to face the right eye 140-2 of the user wearing the wearable device 101. The wearable device 101 that obtained an image and/or video of the user's two eyes (e.g., the left eye 140-1 and/or the right eye 140-2) from the first eye tracking camera 130-1 and/or the second eye tracking camera 130-2 may calculate or determine a position stared at by the user. The position stared at by the user, which is detected by the wearable device 101, may be referred to as a gaze position g, a gaze point, and/or a gaze spot.

Referring to FIG. 1, a screen 120 displayed by the wearable device 101 is illustrated. The wearable device 101 may display a screen 120, including content having binocular parallax b, on the first display 110-1 and the second display 110-2. For example, the wearable device 101 may change a distance of the content from the wearable device 101 recognized by the user, by changing a first position of the content in the first display 110-1 and a second position of the content in the second display 110-2. For example, by adjusting a difference (e.g., a position difference on a horizontal axis of the screen 120) between the first position and the second position, the wearable device 101 may change perspective of the content. As the difference increases, the binocular parallax b of the two eyes formed when looking at the content may increase, and the wearable device 101 may provide a user who views the content with a sense such that the content is approaching. As the difference decreases, the binocular parallax b of the content may decrease, and the wearable device 101 may provide the user who views the content with a sense such that content is moving away.

According to an embodiment of the disclosure, in the wearable device 101, the display area formed by at least one display (e.g., the first display 110-1 and/or the second display 110-2) may cover the entire user's viewable area while the wearable device 101 is worn by the user. In order to provide an immersive user experience (e.g., the mixed reality and/or the virtual reality based on the video see through (VST), the wearable device 101 may display a high-resolution screen 120. In order to display the high-resolution screen 120, at least one display included in the wearable device 101 may include a large number of pixels. In the disclosure, a term “resolution” is used to refer to density of pixels of an image and/or display. The density and/or the resolution of pixels may be measured or parameterized based on units of pixels per inch (ppi) and/or dots per inch (dpi). For example, that a resolution of a first image is lower than a resolution of a second image may indicate that density of pixels in the first image is less than density of pixels in the second image.

According to an embodiment of the disclosure, the wearable device 101 may visualize the screen 120 by using one or more images that are smaller than a size of the display area and/or lower than a resolution of the display area. For example, the wearable device 101 may enlarge (e.g., upscaling) a first image 151 smaller than the size of the display area or lower than the resolution of the display area, and fill it in an entire display area. Referring to FIG. 1, a display area having a size of a width wd and a height hd, and the first image 151 having a width w1 less than the width wd and a height h1 less than the height hd are exemplarily illustrated. The wearable device 101 may obtain or generate the enlarged first image 151 corresponding to the entire display area by enlarging the first image 151 according to a ratio (e.g., wd/w1 and/or hd/h1) between the size of the display area and the size of the first image 151.

In an embodiment of the disclosure, the first image 151 having a resolution lower than the resolution of the entire display area may be provided from, or may be generated by a software application executed by the wearable device 101. Since the software application is executed using the resolution lower than the resolution of the entire display area, the wearable device 101 may obtain the first image 151 to be used to display the screen 120, by using fewer resources (e.g., share of processor, computation of processor, power consumption of battery, bandwidth between processor and memory, and/or capacity of memory) than resources required to obtain another image having the resolution of the entire display area.

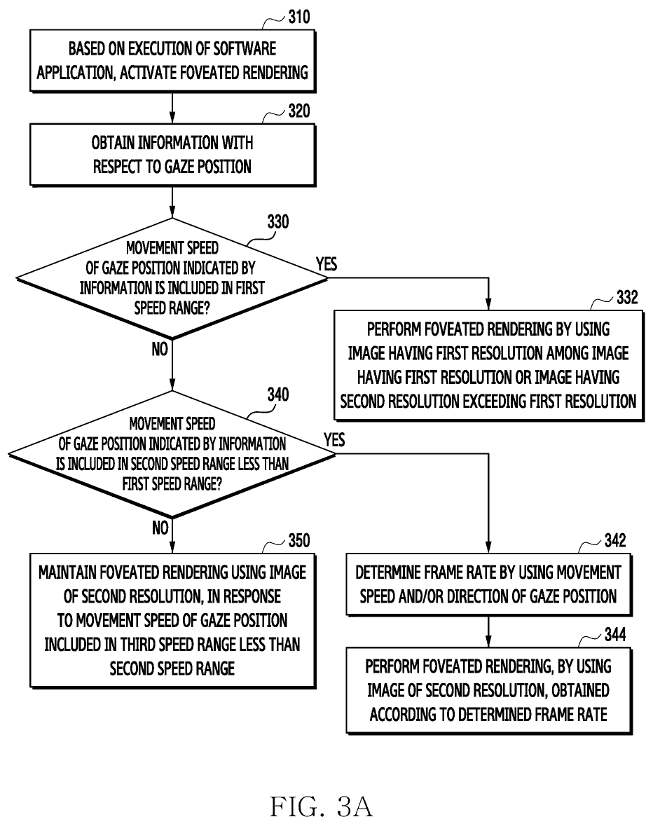

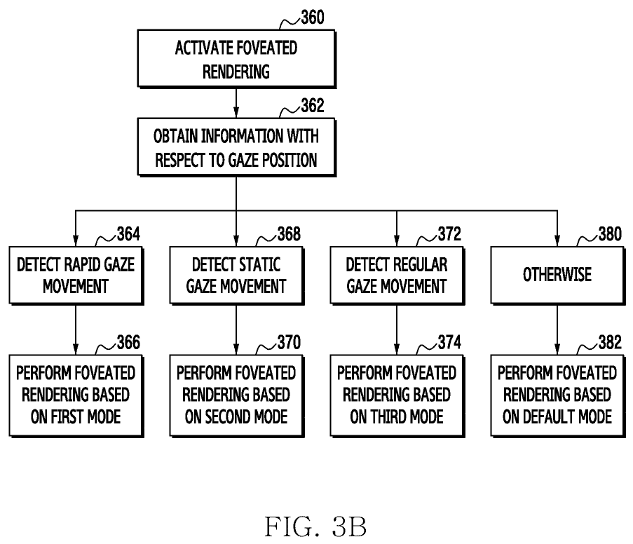

In an embodiment of the disclosure, the wearable device 101 may perform foveated rendering. A user looking in a specific direction clearly recognizes a portion of the field of view including the specific direction and unclearly recognizes the remaining portion of the field of view. The expression “foveated rendering” may be used to refer to the operation of the wearable device 101 to visualize a portion 129 of the display area, which at least partially overlaps the gaze position g of the user wearing the wearable device 101, more clearly than the remaining portion of the display area. The portion 129 may be referred to as a foveated portion, and the remaining portion of the display area distinct from the portion 129 may be referred to as a periphery portion. For example, the foveated rendering may be performed to intensively visualize the portion 129 that is recognized relatively clearly so that the resources of the wearable device 101 are efficiently (or optimally) used. An operation of the wearable device 101 performing the foveated rendering is described with reference to FIGS. 3A and/or 3B.

Referring to FIG. 1, images (e.g., the first image 151 and the second image 152) used for the foveated rendering are illustrated. For example, the wearable device 101 may obtain the first image 151 and/or the second image 152 having a size less than the size of the entire display area based on the execution of the software application. For example, the sizes of the first image 151 and the second image 152 may be smaller than the sizes of the entire display area. The first image 151 and the second image 152 may have different resolutions. For example, a resolution of the first image 151 may be lower than a resolution of the entire display area. For example, the resolution of the second image 152 may be equal to or less than the resolution of the entire display area. For example, the resolution of the second image 152 may be higher than the resolution of the first image 151. In an embodiment of obtaining the first image 151 and the second image 152 synchronized with each other by executing the software application, the wearable device 101 may obtain the second image 152 corresponding to a portion 159 of the first image 151. For example, the wearable device 101 may obtain the second image 152 that more clearly expresses the content of the portion 159 of the first image 151.

In an embodiment of the disclosure, the wearable device 101 may enlarge the first image 151 using the size and/or resolution of the entire display area in order to fill the entire display area. For example, the first image 151 may be related to the entire display area. In an embodiment of obtaining the first image 151 related to the entire display area, the wearable device 101 may determine or detect the portion 159 of the first image 151 corresponding to the portion 129 of the display area at least partially overlapping the gaze position g. The wearable device 101 may calculate or detect the gaze position g used to determine the portion 159 using at least one sensor (e.g., a first eye tracking camera 130-1 and/or a second eye tracking camera 130-2) for detecting the gaze position g.

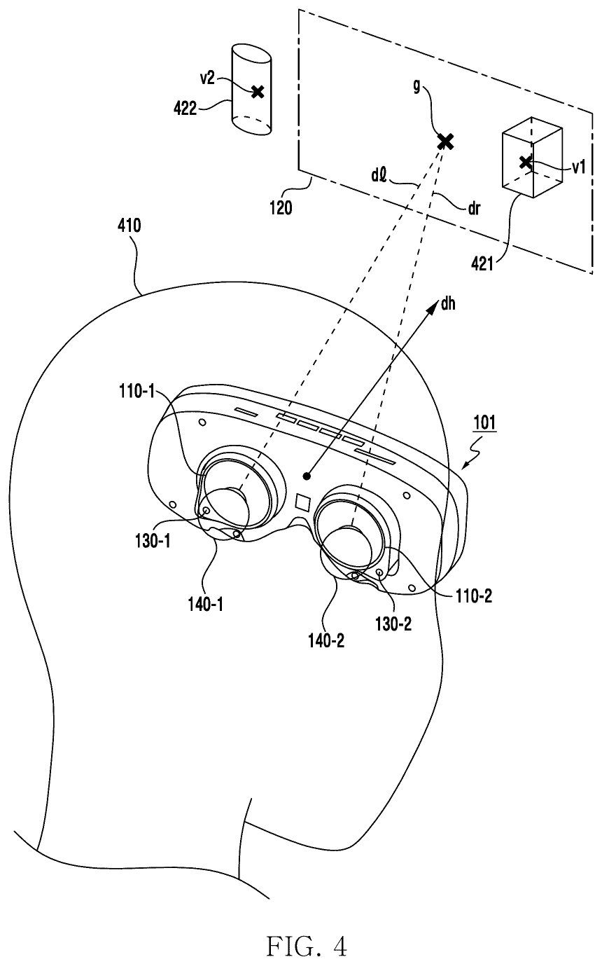

In an embodiment of the disclosure, the wearable device 101 may detect or calculate the gaze position g in the display area using at least one eye (e.g., the left eye 140-1 and/or the right eye 140-2) of the user wearing the wearable device 101 and/or information on motion (or motion of the head) of the wearable device 101 attached to the user's head. According to an embodiment of the disclosure, an operation in which the wearable device 101 determines the gaze position g in the display area and/or the portion 129 of the display area that at least partially overlaps the gaze position g is described with reference to FIG. 4.

Referring to FIG. 1, the portion 159 of the first image 151 may correspond to the portion 129 of the display area overlapping the gaze position g. The wearable device 101 may obtain or generate the second image 152 corresponding to the portion 159 of the first image 151 and having a second resolution exceeding a first resolution of the first image 151. The second image 152 may be referred to as a partial image of the first image 151 in terms of corresponding to a portion of the first image 151, and the first image 151 may be referred to as an entire image. According to the difference in resolution, the first image 151 may be referred to as a low-resolution image, and the second image 152 may be referred to as a high-resolution image. As a non-limiting example, the width w1 and the height h1 of the first image 151 may be the same as a width w2 and a height h2 of the second image 152. All of the sizes of the first image 151 and the second image 152 may be smaller than the size of the entire display area (or the screen 120). For example, the size of the second image 152 may substantially match the size of the portion 129 of the display area corresponding to the portion 159 of the first image 151.

According to an embodiment of the disclosure, the wearable device 101 may control at least one display in order to display the first image 151 mapped to the entire display area, and the second image 152 according to a position of the portion 159 in the first image 151. For example, in the screen 120 displayed on the entire display area, the first image 151 may be enlarged according to the size of the entire display area, and the second image 152 may be disposed in the portion 129 of the display area related to the portion 159. For example, since the first image 151 having a resolution lower than the resolution of the display is mapped to the entire display area, the resolution of the first image 151 enlarged to be mapped to the entire display area may be lower than the resolution of the display. For example, when the second image 152 having the resolution of the display and having the size of the portion 129 is displayed on the portion 129, the resolution of the second image 152 displayed through the portion 129 may be substantially the same as the resolution of the display.

Referring to FIG. 1, in an embodiment of displaying the second image 152 on the portion 129 overlapping the gaze position g, the wearable device 101 may clearly provide content in the portion 129 to the user staring at the portion 129 using the second image 152 having the resolution higher than the resolution of the first image 151. According to an embodiment of the disclosure, the wearable device 101 may measure or calculate the displacement (e.g., speed and/or acceleration) of the gaze position g in the display area based on motion of the user's at least one eye (e.g., the left eye 140-1 or the right eye 140-2). For example, the wearable device 101 may obtain or determine information with respect to the gaze position g using at least one sensor.

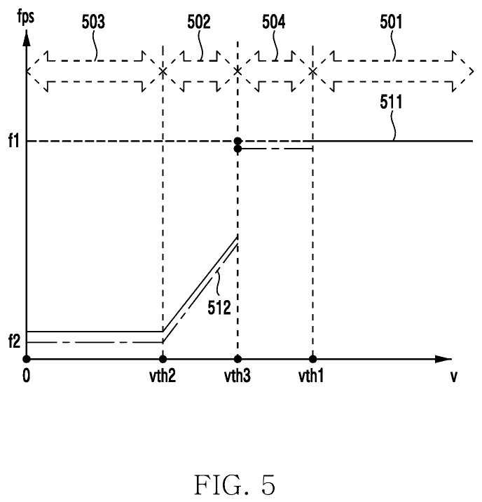

In an embodiment of the disclosure, the wearable device 101 may change or determine a parameter (e.g., a size of the foveated portion, a period performing the foveated rendering, a frequency, and/or a frame rate) related to the foveated rendering based on the information with respect to the gaze position g. For example, the wearable device 101 may determine whether to obtain the second image 152 using a software application executed to generate the screen 120 based on the information with respect to the gaze position g. For example, the wearable device 101 may determine or calculate a period (e.g., a frame rate) of obtaining the second image 152 using the software application based on the information with respect to the gaze position g. An operation in which the wearable device 101 controls execution of the foveated rendering using the information is described with reference to FIGS. 5, 6A, 6B, 7A, 7B, 8A, 8B, 9A, and 9B.

As described above, according to an embodiment of the disclosure, the wearable device 101 may reduce or optimize a resource occupied for the foveated rendering, by performing dynamic foveated rendering. For example, the wearable device 101 may obtain or generate the screen 120 to be displayed through the entire display area, by using only the first image 151 without the second image 152. For example, the wearable device 101 may reduce the frequency (e.g., the frame rate) of obtaining the second image 152 to be combined on the first image 151 enlarged to be displayed in the entire display area to be lower than a frequency of obtaining the first image 151. For example, that the user moves the gaze position g quickly may mean that the user is not focused on the portion 129 of the display area overlapping the gaze position g. The wearable device 101 may estimate the exemplified user's intention by using a movement speed of the gaze position g. Using the estimated intention, the wearable device 101 may reduce the frequency at which the second image 152 for providing clear content is obtained. For example, according to the movement speed of the gaze position g, the wearable device 101 may increase (e.g., while the movement speed decreases) or decrease (e.g., while the movement speed increases) the frequency of performing the foveated rendering by using the second image 152.

Hereinafter, a hardware configuration of the wearable device 101 configured to perform the foveated rendering, is described with reference to FIGS. 2A and/or 2B.

FIGS. 2A and 2B illustrate block diagrams of a wearable device according to various embodiments of the disclosure. The wearable device 101 of FIGS. 2A and/or 2B may include the wearable device 101 of FIG. 1.

Referring to FIG. 2A, the wearable device 101 according to an embodiment may include a processor 210, memory 215, a display 110 (e.g., a first display 110-1 and/or a second display 110-2 of FIG. 1), and/or a sensor 220 (e.g., an image sensor 130 and/or a motion sensor 222). The processor 210, the memory 215, the display 110, and/or the sensor 220 may be electrically and/or operatively connected to each other by an electronic component, such as a communication bus 202. In the disclosure, the operative connection of electronic components may include a direct connection established between the electronic components and/or an indirect connection established between the electronic components so that a first electronic component among the electronic components is controlled by a second electronic component among the electronic components. The type and/or number of the electronic components included in the wearable device 101 is not limited to that illustrated in FIG. 2A. For example, the wearable device 101 may include only some of the electronic components illustrated in FIG. 2A.

The processor 210 of the wearable device 101 according to an embodiment may include circuitry (e.g., processing circuitry) for processing data based on one or more instructions. The circuitry for processing the data may include, for example, an arithmetic and logic unit (ALU), a field programmable gate array (FPGA), a central processing unit (CPU), and/or an application processor (AP). In an embodiment of the disclosure, the wearable device 101 may include one or more processors. According to an embodiment of the disclosure, a structure of the processor 210 is not limited to an embodiment of the disclosure, and at least one circuit may be formed in the processor as a separate processor physically separated from the outside. The processor 210 may have a structure of a multi-core processor, such as a dual core, a quad core, a hexa core, and/or an octa core. The multi-core processor structure of the processor 210 may include a structure (e.g., a big-little structure) based on a plurality of core circuitry, which is distinguished by power consumption, clock, and/or calculation amount per unit time. In an embodiment including the processor 210 having the multi-core processor structure, operations and/or functions of the disclosure may be performed individually or collectively by one or more cores included in the processor 210.

The memory 215 of the wearable device 101 according to an embodiment may include an electronic component for storing data and/or instructions inputted to the processor 210 or outputted from the processor 210. The memory 215 may include, for example, volatile memory, such as a random-access memory (RAM) and/or non-volatile memory, such as read-only memory (ROM). The volatile memory may include, for example, at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, hard disk, compact disk, and embedded multimedia card (eMMC). In an embodiment of the disclosure, the memory 215 may be referred to as storage.

In an embodiment of the disclosure, the display 110 of the wearable device 101 may output visualized information to a user of the wearable device 101. The display 110 arranged in front of eyes of the user wearing the wearable device 101 may be disposed on at least a portion of a housing of the wearable device 101 (e.g., the first display 110-1 and/or the second display 110-2 of FIG. 1). For example, the display 110 may be controlled by the processor 210 including circuitry, such as a CPU 211, a graphics processing unit (GPU) 212, and/or a display processing unit (DPU) 213 to output the visualized information to the user. The display 110 may include a flexible display, a flat panel display (FPD), and/or an electronic paper. The display 110 may include a liquid crystal display (LCD), a plasma display panel (PDP), and/or one or more light emitting diodes (LEDs). The LED may include an organic LED (OLED). The embodiment is not limited thereto, and for example, in case that the wearable device 101 includes a lens for transmitting external light (or ambient light), the display 110 may include a projector (or projection assembly) for projecting light onto the lens. In an embodiment of the disclosure, the display 110 may be referred to as a display panel and/or display module. Pixels included in the display 110 may be disposed toward either of the user's two eyes when worn by the user of the wearable device 101. For example, the display 110 may include display areas (or active areas) corresponding to each of the user's two eyes.

In an embodiment of the disclosure, the sensor 220 of the wearable device 101 may generate electrical information that may be processed by the processor 210 and/or the memory 215 from non-electronic information related to the wearable device 101. For example, the sensor 220 may include a global positioning system (GPS) sensor for detecting a geographic location of the wearable device 101. In addition to the GPS method, the sensor 220 may generate information indicating the geographic location of the wearable device 101 based on a global navigation satellite system (GNSS), for example, such as galileo and beidou (compass). The information may be stored in the memory 215, processed by the processor 210, and/or or transmitted to another electronic device distinct from the wearable device 101 though communication circuitry.

Referring to FIG. 2A, the image sensor 130 and/or the motion sensor 222 are illustrated as an example of the sensor 220 included in the wearable device 101. The image sensor 130 may include one or more optical sensors (e.g., a charged coupled device (CCD) sensor and a complementary metal oxide semiconductor (CMOS) sensor) that generate an electrical signal indicating a color and/or brightness of light. The image sensor 130 may be referred to as a camera. A plurality of optical sensors included in the image sensor 130 may be disposed in the form of a 2 dimensional (2D) array. The image sensor 130 may generate 2 dimensional frame data corresponding to light reaching the optical sensors of the 2 dimensional array, by substantially simultaneously obtaining electrical signals of each of the plurality of optical sensors. For example, photo data captured using the image sensor 130 may mean a 2 dimensional frame data obtained from the image sensor 130. For example, video data captured using the image sensor 130 may mean a sequence of a plurality of 2 dimensional frame data obtained from the image sensor 130 along a frame rate. The image sensor 130 may further include a flash light for outputting light toward the direction which is positioned toward a direction in which the image sensor 130 receives light.

According to an embodiment of the disclosure, the wearable device 101 may include a plurality of image sensors disposed toward different directions, as an example of the image sensor 130. As described above with reference to FIG. 1, the plurality of image sensors may include an eye tracking camera (e.g., a first eye tracking camera 130-1 and/or a second eye tracking camera 130-2 of FIG. 1) configured to be arranged toward an eye of the user wearing the wearable device 101. The plurality of image sensors may include an outward camera. The processor 210 may identify a direction of the user's gaze by using an image and/or video obtained from the eye tracking camera. The eye tracking camera may include an infrared (IR) sensor. The eye tracking camera may be referred to as an eye sensor and/or an eye tracker.

For example, the outward camera may be disposed facing in front (e.g., a direction in which two eyes may be directed) of the user wearing the wearable device 101. The wearable device 101 may include a plurality of outward cameras. The embodiment is not limited thereto, and the outward camera may be disposed toward the external space. Using the image and/or video obtained from the outward camera, the processor 210 may identify an external object. For example, the processor 210 may identify a position, shape, and/or gesture (e.g., a hand gesture) of a hand of the user wearing the wearable device 101 based on the image and/or video obtained from the outward camera. Using an image and/or video of the external environment, obtained from the outward camera, the processor 210 may recognize or track one or more objects in the external environment.

According to an embodiment of the disclosure, the motion sensor 222 may output an electrical signal indicating gravitational accelerations, accelerations, and/or angular velocities of a plurality of axes (e.g., x-axis, y-axis, and z-axis) that are perpendicular to each other and based on a designated origin in the wearable device 101 and/or the motion sensor 222. For example, the processor 210 may repeatedly receive or obtain sensor data including accelerations, angular velocities, and/or magnitudes of magnetic field of the number of the plurality of axes, from the motion sensor 222 based on a designated period (e.g., 1 millisecond). In an embodiment of the disclosure, the motion sensor 222 may be referred to as an inertial measurement unit (IMU). The sensor 220 included in the wearable device 101 is not limited to the above, and may include a grip sensor, a proximity sensor, a heart rate sensor, a fingerprint sensor, an illuminance sensor, and/or a time-of-flight (ToF) sensor. Using the motion sensor 222, the processor 210 may detect a motion (e.g., a motion of the wearable device 101 caused by the user wearing the wearable device 101) of the wearable device 101.

According to an embodiment of the disclosure, in the memory 215 of the wearable device 101, one or more instructions (or commands) indicating data to be processed by the processor 210 of the wearable device 101 and calculation and/or operation to be performed may be stored. A set of one or more instructions may be referred to as a program, firmware, operating system, process, routine, sub-routine and/or software application (hereinafter referred to as an application). For example, the wearable device 101 and/or the processor 210 may perform at least one of operations of FIGS. 3A, 3B, 6A, 6B, 7A, 7B, 8A, 8B, 9A, and 9B when set of a plurality of instructions distributed in the form of an operating system, firmware, driver, program, and/or software application is executed. Hereinafter, the fact that the software application is installed in the electronic device 101 may mean that one or more instructions provided in the form of the software application (or package) are stored in the memory 215, and the one or more applications are stored in an executable format (e.g., a file having an extension designated by the operating system of the wearable device 101) by the processor 210. For example, the application may include a program and/or a library related to a service provided to the user.

Referring to FIG. 2A, programs installed in the electronic device 101 may be included in any one layer among different layers including an application layer 240, a framework layer 250, and/or a hardware abstraction layer (HAL) 280, based on a target. For example, programs (e.g., a module, or a driver) designed to target the hardware (e.g., the display 110 and/or the sensor 220) of the electronic device 101 may be included in the hardware abstraction layer (HAL) 280. The framework layer 250 may be referred to as an XR framework layer, in terms of including one or more programs for providing an extended reality (XR) service. For example, the layers illustrated in FIG. 2A are logically (or for convenience of explanation) divided and may not mean that an address space of the memory 215 is divided by the layers.

For example, programs (e.g., a location tracker 271, a space recognizer 272, a gesture tracker 273, a gaze tracker 274, and/or a face tracker 275) designed to target at least one of the hardware abstraction layer (HAL) 280 and/or the application layer 240 may be included in the framework layer 250. The programs included in the framework layer 250 may provide an application programming interface (API) that may be executed (or invoked or called) based on another program.

For example, in the application layer 240, a program designed to target the user of the electronic device 101 may be included. As an example of programs included in the application layer 240, an extended reality (XR) system user interface (UI) 241 and/or an XR application 242 are exemplified, but the embodiment is not limited thereto. For example, the programs (e.g., the software application) included in the application layer 240 may cause execution of functions supported by the programs included in the framework layer 250, by calling the API.

For example, the wearable device 101 may display one or more visual objects for performing interaction with the user on the display 110 based on execution of the XR system UI 241. The visual object may mean an object that may be disposed in the screen for transmission and/or interaction of information, such as text, an image, an icon, a video, a button, a check box, a radio button, a text box, a slider and/or a table. The visual object may be referred to as a visual guide, a virtual object, a visual element, a UI element, a view object, and/or a view element. The electronic device 101 may provide the user with functions available in the virtual space based on execution of the XR system UI 241.

Referring to FIG. 2A, a lightweight renderer 243 and/or an XR plug-in 244 are illustrated to be included in the XR system UI 241, but are not limited thereto. For example, based on the XR system UI 241, the processor 210 may execute the lightweight renderer 243 and/or the XR plug-in 244 in the framework layer 250.

For example, based on the execution of the lightweight renderer 243, the electronic device 101 may obtain a resource (e.g., API, system process, and/or library) used to define, create, and/or execute a rendering pipeline in which a partial change is permitted. The lightweight renderer 243 may be referred to as a lightweight render pipeline in terms of defining the rendering pipeline in which the partial change is permitted. The lightweight renderer 243 may include a renderer (e.g., a prebuilt renderer) built before execution of the software application. For example, the wearable device 101 may obtain the resource (e.g., API, system process, and/or library) used to define, create, and/or execute the entire rendering pipeline based on execution of the XR plug-in 244. The XR plug-in 244 may be referred to as an open XR native client in terms of defining (or setting) the entire rendering pipeline.

For example, the electronic device 101 may display a screen indicating at least a portion of the virtual space on the display 110 based on execution of the XR application 242. A XR plug-in 244-1 included in the XR application 242 may include instructions that support a function similar to that of the XR plug-in 244 of the XR system UI 241. Among a description of the XR plug-in 244-1, a description that overlap with a description of the XR plug-in 244 may be omitted. The wearable device 101 may cause execution of a virtual space manager 251 based on the execution of the XR application 242.

According to an embodiment of the disclosure, the wearable device 101 may provide a virtual space service based on the execution of the virtual space manager 251. For example, the virtual space manager 251 may include a platform for supporting the virtual space service. Based on the execution of the virtual space manager 251, the wearable device 101 may identify a virtual space formed based on the user's location indicated by the data obtained through the sensor 220, and may display at least a portion of the virtual space on the display 110. The virtual space manager 251 may be referred to as a composition presentation manager (CPM).

For example, the virtual space manager 251 may include a runtime service 252. For example, the runtime service 252 may be referred to as an OpenXR runtime module (or OpenXR runtime program). The wearable device 101 may execute at least one of a user's pose prediction function, a frame timing function, and/or a space input function based on the execution of the runtime service 252. For example, the electronic device 101 may perform rendering for the virtual space service to the user based on the execution of the runtime service 252. For example, based on the execution of the runtime service 252, a function related to the virtual space that may be executed by the application layer 240 may be supported.

For example, the virtual space manager 251 may include a pass-through manager 253. Based on execution of the pass-through manager 253, the wearable device 101 may display an image and/or video indicating an actual space obtained through the outward camera by overlapping on at least a portion of the screen, while displaying a screen (e.g., the screen 120 of FIG. 1) indicating the virtual space on the display 110.

For example, the virtual space manager 251 may include an input manager 254. The wearable device 101 may identify data (e.g., sensor data) obtained by executing one or more programs included in a perception service layer 270 based on execution of the input manager 254. The wearable device 101 may identify a user input related to the wearable device 101 by using the obtained data. The user input may be related to the user's motion (e.g., hand gesture), gaze, and/or utterance identified by the sensor 220 (e.g., an image sensor 130, such as the outward camera). The user input may be identified based on an external electronic device connected (or paired) through the communication circuitry.

For example, a perception abstract layer 260 may be used for data exchange between the virtual space manager 251 and the perception service layer 270. In terms of being used for the data exchange between the virtual space manager 251 and the perception service layer 270, the perception abstract layer 260 may be referred to as an interface. For example, the perception abstract layer 260 may be referred to as OpenPX. The perception abstract layer 260 may be used for a perception client and a perception service.

According to an embodiment of the disclosure, the perception service layer 270 may include one or more programs for processing data obtained from the sensor 220. The one or more programs may include at least one of the location tracker 271, the space recognizer 272, the gesture tracker 273, the gaze tracker 274, and/or the face tracker 275. The type and/or number of one or more programs included in the perception service layer 270 is not limited as illustrated in FIG. 2A.

For example, the wearable device 101 may identify a posture of the wearable device 101 by using the sensor 220 based on execution of the location tracker 271. Based on the execution of the location tracker 271, the wearable device 101 may identify the 6 degrees of freedom pose (6 dof pose) of the wearable device 101 by using data obtained using the outward camera (e.g., the motion sensor 222 including the image sensor 130) and/or the IMU (e.g., the gyro sensor, the acceleration sensor, and/or the geomagnetic sensor). The location tracker 271 may be referred to as a head tracking (HeT) module (or a head tracker, a head tracking program).

For example, the wearable device 101 may obtain information for providing a 3 dimensional (3D) virtual space corresponding to a surrounding environment (e.g., the external space) of the wearable device 101 (or the user of the wearable device 101) based on execution of the space recognizer 272. The wearable device 101 may reproduce the surrounding environment of the wearable device 101 in 3 dimensions by using the data obtained using the outward camera (e.g., the image sensor 130) based on the execution of the space recognizer 272. The wearable device 101 may identify at least one of a plane, an inclination, and a staircase based on the surrounding environment of the wearable device 101 reproduced in 3 dimensions based on the execution of the space recognizer 272. The space recognizer 272 may be referred to as a scene understanding (SU) module (or scene understanding (SU) program).

For example, the wearable device 101 may identify (or recognize) a pose and/or gesture of the user's hand of the wearable device 101 based on execution of the gesture tracker 273. For example, the wearable device 101 may identify the pose and/or gesture of the user's hand by using data obtained from the outward camera (e.g., the image sensor 130) based on the execution of the gesture tracker 273. For example, the wearable device 101 may identify the pose and/or gesture of the user's hand based on the data (or an image) obtained using the outward camera based on the execution of the gesture tracker 273. The gesture tracker 273 may be referred to as a hand tracking (HaT) module (or hand tracking program), and/or a gesture tracking module.

For example, the wearable device 101 may identify (or track) motion of the user's eyes of the wearable device 101 based on execution of the gaze tracker 274. For example, the wearable device 101 may identify the motion of the user's eyes by using data obtained from the eye tracking camera (e.g., the image sensor 130) based on the execution of the gaze tracker 274. The gaze tracker 274 may be referred to as an eye tracking (ET) module (or an eye tracking program), and/or a gaze tracking module.

For example, the wearable device 101 may obtain or generate information related to the user's face of the wearable device 101 based on the execution of the face tracker 275. For example, based on the execution of the face tracker 275, the wearable device 101 may obtain or generate information related to the motion and/or expression of the face of the user wearing the wearable device 101 from the data obtained from the image sensor 130. The face tracker 275 may be referred to as face tracking (FT) (or face tracking program), and/or a face tracking module.

Referring to FIG. 2A, as an example of the processor 210, the CPU 211, the graphics processing unit (GPU) 212, and/or the display processing unit (DPU) 213 are illustrated. A foveated renderer 290 may include instructions for foveated rendering. The processor 210 (e.g., the DPU 213) that executed the foveated renderer 290 may obtain at least one image to be displayed at least partially in the display area of the display 110 in the software application (e.g., a software application executed by the CPU 211 and/or the GPU 212). The processor 210 that executed the foveated renderer 290 may divide the display area of the display 110 into a foveated portion (e.g., a portion 129 of FIG. 1) and a periphery portion, by using a gaze position calculated using the location tracker 271 and/or the gaze tracker 274. For example, the processor 210 that detected coordinate values of the gaze position may determine a portion of the display area including the coordinate values as the foveated portion. The DPU 213 that executed the foveated renderer 290 may obtain at least one image corresponding to each of the foveated portion and the periphery portion, having a size smaller than a size of the entire display area of the display 110, or having a resolution lower than a resolution of the display area.

The processor 210 that executed the foveated renderer 290 may obtain or generate a composite image to be displayed on the display 110, by synthesizing an image corresponding to the foveated portion and an image corresponding to the periphery portion. For example, the processor 210 may enlarge the image corresponding to the periphery portion to the size of the entire display area of the display 110, by performing upscaling. The processor 210 may generate the composite image to be displayed on the display 110, by combining the image corresponding to the foveated portion on the enlarged image. Along a boundary line of the image corresponding to the foveated portion, the processor 210 may mix the enlarged image and the image corresponding to the foveated portion, by applying a visual effect, such as blur.

Referring to FIG. 2B, the wearable device 101 may execute a composition presentation manager (CPM), which is a program for rendering based on a virtual space. The virtual space manager 251 may include a platform for supporting the virtual space service. The virtual space manager 251 may include the runtime service 252 (e.g., OpenXR Runtime), a panel rendering 255 (e.g., a 2D Panel Renderer), and an XR compositor 256. The wearable device 101 may execute at least one of the user's pose prediction function, the frame timing function, and/or the space input function based on the execution of the runtime service 252. The wearable device 101 may display at least one image (video) on a panel (e.g., a 2D panel) to be displayed through the display based on execution of the panel rendering 255. Based on execution of the XR compositor 256, the wearable device 101 may synthesize an image (hereinafter, a pass-through image) of an external space photographed through a camera on the virtual space and an image of a virtual area. The wearable device 101 may generate the composite image, by merging the pass-through image and the image for the virtual area, by executing the XR compositor 256. The wearable device 101 may transmit the composite image to a display buffer so that the composite image is displayed.

The wearable device 101 may execute a space flinger 291. The space flinger 291 may be a program configured to support functions for displaying the image in the 3 dimensional virtual space. The wearable device 101 may perform a preprocessing operation for rendering based on the virtual space manager 251 by executing the space flinger 291. For example, based on the execution of the space flinger 291, the wearable device 101 may process image information provided by the application (e.g., the XR application 242, applications 240 that provide a general 2D screen other than the XR, and the XR system UI 241 provided by a system application). The space flinger 291 may include a system screen manager 292, an input router 293, and/or an impress engine 294.

By executing the system screen manager 292 included in the space flinger 291, the wearable device 101 may display the system UI 241. The system UI 241 may be loaded by the wearable device 101 that executed the system screen manager 292, based on a call of a spatializer API and/or a same-process private API. The space flinger 291 may determine a layout (e.g., location and/or display order) in a screen of the XR system UI 241. The system screen manager 292 may transmit information (e.g., the image information) for rendering the XR system UI 241 to the virtual space manager 251 according to the determined layout.

The input router 293 included in the space flinger 291 may be a program configured to process a user input (e.g., a user input on the system screen and/or an application screen). The input router 293 may map a user input detected by a sensor of the wearable device 101 to at least one of one or more software applications (e.g., a system application executed to provide the XR application 242, the applications 240, and/or the XR system UI 241) mapped to the virtual space by the space flinger 291. For example, mapping of the user input may include an operation of executing instructions (e.g., sub-routine and/or event handler) of a software application for processing the user input.

The impress engine 294 included in the space flinger 291 may be a renderer (e.g., the lightweight renderer) for generating an image to be located in the virtual space of the virtual space manager 251. The impress engine 294 may be executed for rendering for the XR system UI 241. In case that resources for rendering based on the impress engine 294 are insufficient, the wearable device 101 may execute an external rendering engine.

Referring to FIG. 2B, the XR application 242 is illustrated as an example of software applications executable by the wearable device 101. The XR application 242 may include an immersive application, such as a 3D game. The wearable device 101 that executed the XR application 242 may perform rendering for virtual space based on the XR application 242, by executing the virtual space manager 251.

Referring to FIG. 2B, as an example of the software application executable by the wearable device 101, the applications 240 (e.g., a first application 240-1, a second application 240-2, . . . , an Nth application 240-N) different from the XR application 242 is illustrated. Based on the execution of the application 240, the wearable device 101 may obtain an image (e.g., window and/or activity) in the form of a 2 dimensional panel (e.g., a square and/or a square with rounded corners). The wearable device 101 that executed the application 240 may execute the space flinger 291 in order to provide the image obtained based on the execution of the application 240 through the virtual space. The wearable device 101 that executed the space flinger 291 may obtain information (e.g., RGB information based on an object referred to as a SurfaceComposer) related to the image from the application 240. The wearable device 101 may obtain the information from the application 240 through the spatializer API. By executing the space flinger 291, the wearable device 101 may generate information (e.g., dual image information based on binocular parallax) to be used to display the image in three dimensions. The information may be processed by the virtual space manager 251.

The foveated rendering of the disclosure may be performed by the XR compositor 256 of FIG. 2B. The wearable device 101 that executed the XR compositor 256 may obtain information for the foveated rendering from the space flinger 291. The wearable device 101 that obtained the information may generate or obtain visualizable information by a display (e.g., a display system configured to be disposed toward the eyes of the user wearing the wearable device 101, including the first display 110-1 and the second display 110-2 of FIG. 1) as information that may be processed by a perception HAL 281, a system HAL 282, and/or a XR HAL 283. By controlling the display system of the wearable device 101 using the information, the wearable device 101 may perform the foveated rendering.

Hereinafter, an operation of the wearable device 101 and/or the processor 210 performing the foveated rendering is described with reference to FIGS. 3A and/or 3B.

FIGS. 3A and 3B illustrate flowcharts of a wearable device according to various embodiments of the disclosure. A wearable device 101 of FIGS. 1 and/or 2A and/or a processor 210 of FIG. 2A may perform at least one of operations of FIG. 3A. For example, at least some operations among the operations of FIG. 3A may be performed by a wearable device that executed a foveated renderer 290 of FIG. 2A. For example, at least some operations among the operations of FIG. 3A may be performed by the processor 210 and/or a DPU 213 of FIG. 2A. An order in which the operations of FIG. 3A are performed is not limited to an order illustrated in FIG. 3A. For example, the processor of the wearable device may perform the operations of FIG. 3A in an order different from the order illustrated in FIG. 3A. For example, the processor of the wearable device may perform at least two operations among the operations of FIG. 3A substantially simultaneously.

Referring to FIG. 3A, in operation 310, the processor of the wearable device according to an embodiment may activate foveated rendering based on execution of a software application. For example, the processor may enable the foveated rendering of the operation 310 based on execution of a software application (e.g., a gallery application for viewing photos) configured to display static content. For example, the processor may detect a parameter and/or a flag related to the foveated rendering, from a resource of a file (e.g., a package file) for the software application. The resource may include a manifest (e.g., an extended marked-up language (xml) file with a designated file name and/or a designated extension, such as “manifest.xml”). The processor that detected the designated parameter and/or the designated flag indicating that the foveated rendering is allowed from the resource may activate the foveated rendering of the operation 310. Based on activation of the foveated rendering of the operation 310, the processor may perform operations after the operation 310 of FIG. 3A.

Referring to FIG. 3A, in operation 320, the processor of the wearable device according to an embodiment may obtain information with respect to a gaze position. The processor may obtain information with respect to the position of the gaze of the operation 320 by using sensor data of a sensor 220 (e.g., an image sensor 130 and/or a motion sensor 222) of FIG. 2A. For example, the information with respect to the gaze position may include coordinate values of the gaze position based on a coordinate system linked to a display (e.g., a display 110 of FIGS. 1 and 2A). For example, the information with respect to the gaze position may include a speed, velocity, and/or displacement at the gaze position indicated by the coordinate values. For example, the information with respect to the gaze position may include a direction, speed, and/or velocity in which the gaze position is moved, referred to as a motion vector. For example, a size of the motion vector may correspond to the speed (e.g., a movement speed) of the gaze position. An operation of the wearable device for obtaining the information with respect to the gaze position of the operation 320 is described with reference to FIG. 4.

Referring to FIG. 3A, in operation 330, the processor of the wearable device according to an embodiment may check whether the movement speed of the gaze position indicated by the information of the operation 320 is included in a first speed range. The first speed range may be formed to check the movement speed of the gaze position greater than a first threshold speed. The processor that detected the speed included in the first speed range (330—Yes), may perform operation 332. The processor that detected a speed (e.g., the first speed range and/or a speed less than the first threshold speed) different from the first speed range (330—No), may perform operation 340. For example, in case that the movement speed of the gaze position indicated by the information of the operation 320 is too fast, the processor may perform the operation 332.

Referring to FIG. 3A, in the operation 332, the processor of the wearable device according to an embodiment may perform the foveated rendering by using an image having a first resolution among the image having the first resolution or an image having a second resolution exceeding the first resolution. The processor may display or fill the image having the first resolution on both a foveated portion and a periphery portion of a display area. While detecting the movement speed of the gaze position included in the first speed range, the processor may stop displaying the image of the second resolution on the foveated portion, by performing the operation 332. For example, while the user moves the gaze position to a portion different from the foveated portion, the movement speed of the gaze position may increase to the first speed range. In the above example, the processor may stop displaying the image of the second resolution (e.g., a high-resolution image) on the foveated portion and may only perform rendering of the image of the first resolution (e.g., a low-resolution image). Since rendering for the high-resolution image is omitted, the processor performing the operation 332 may respond to the movement of the gaze position at a faster speed.

Referring to FIG. 3A, in the operation 340, according to an embodiment of the disclosure, the processor of the wearable device may check whether the movement speed (e.g., speed) of the gaze position indicated by the information of the operation 320 is included in the second speed range less than the first speed range. The second speed range may be formed to check the movement speed of the gaze position slower than the first threshold speed. The second speed range may be set to check the movement speed of the gaze position lower than the first threshold speed and greater than the second threshold speed less than the first threshold speed. The processor that detected the movement speed of the gaze position included in the second speed range (340-Yes) may perform at least one of operations 342 and 344. The processor that detected the movement speed (e.g., a movement speed less than the second threshold speed) different from the second speed range (340—No), may perform operation 350.

Referring to FIG. 3A, in the operation 342, the processor of the wearable device according to an embodiment may determine a frame rate by using the movement speed and/or direction of the gaze position. In case that the direction of the gaze position is maintained in a designated angular range for a designated time, the processor may determine the frame rate according to the movement speed of the gaze position. For example, in case that the gaze position moves at a specific movement speed along a specific direction, the processor may determine the frame rate according to the movement speed of the gaze position. For example, the processor may determine the frame rate for the foveated portion so that a fixed image is displayed on the foveated portion while the gaze position is moved in the foveated portion. For example, as the movement speed of the gaze position decreases, the frame rate determined by the operation 342 may decrease. A frame rate determined by a processor that detected a gaze position moved at a constant speed along the specific direction is exemplarily described with reference to FIG. 5. For example, in case that the gaze position is moved in an irregular direction in the second speed range, the processor may determine the frame rate of the operation 342 at a designated frame rate (e.g., the frame rate at which the foveated rendering of the operation 332 is performed).

In an embodiment of the disclosure, the processor performing the operation 342 may change a size of the foveated portion together with the frame rate of the operation 342. For example, the size of the foveated portion may be changed, in inverse proportion to the movement speed of the gaze position. For example, as the movement speed of the gaze position increases, the processor may decrease the size of the foveated portion. The size of the foveated portion may be increased, in proportion to the movement speed of the gaze position, in order to maintain the frame rate or reduce an amount of increase in the frame rate. The gaze position may be changed not only by a movement of a pupil, but also by the user's motion (e.g., rotation of at least a portion of the user's body, such as the head) different from the pupil.

Referring to FIG. 3A, in the operation 344, according to an embodiment of the disclosure, the processor of the wearable device, may perform the foveated rendering, by using the image of the second resolution, obtained according to the frame rate determined by the operation 342. The processor performing the operation 344 may perform rendering with respect to the foveated portion, by using the image of the second resolution, obtained using the frame rate determined by the operation 342. Using the image having the first resolution less than the second resolution, the processor may perform rendering with respect to the periphery portion. The rendering with respect to the periphery portion may be performed according to a frame rate determined by the operation 342, similar to the rendering with respect to the foveated portion.

Referring to FIG. 3A, in the operation 350, according to an embodiment of the disclosure, the processor of the wearable device, may maintain the foveated rendering using the image of the second resolution, in response to a movement speed of a gaze position included in a third speed range less than the second speed range. The third speed range may be formed to check the movement speed of the gaze position slower than the second speed range. The third speed range may be set to check the movement speed of the gaze position less than the second threshold speed. The processor that detected the movement speed of the gaze position included in the third speed range may perform the operation 350. In the operation 350, the processor may maintain displaying the image of the second resolution on the foveated portion.

For example, in case that the movement speed of the gaze position is lowered from the second speed range to the third speed range, the processor may perform the rendering with respect to the foveated portion according to a frame rate less than the frame rate determined by the operation 342, while performing the rendering with respect to the periphery portion according to the frame rate determined by the operation 342.

For example, the processor may maintain displaying a single image displayed on the foveated portion. Displaying the single image on the foveated portion by the processor using the operation 350 may be performed until the gaze position that is moved in the third speed range reaches a boundary line of the foveated portion. The processor that detected the gaze position that reached the boundary line of the foveated portion may change a position and/or size of the foveated portion. The processor may re-obtain or generate the image of the second resolution, according to the changed position and/or the changed size of the foveated portion.

As described above, in response to the movement speed of the gaze position higher than the first threshold speed, the processor may stop controlling the display using the image of the second resolution lower than the first resolution in order to fill the entire display area of the display with the image of the first resolution. The processor may control the display, in order to display the image in the foveated portion and display the image in the periphery portion, by using a direction in which the gaze position is moved and/or the movement speed and frame rate of the gaze position, in response to the movement speed of the gaze position that is less than the first threshold speed and higher than the second threshold speed. The processor may control the display so that one image is displayed in the foveated portion, in response to the movement speed of the gaze position less than the second threshold speed.

FIG. 3B illustrates an operation of a wearable device according to a gaze movement. In operation 360, according to an embodiment of the disclosure, a processor of the wearable device, may activate foveated rendering. The operation 360 of FIG. 3B may be performed similarly to operation 310 of FIG. 3A. In operation 362, according to an embodiment of the disclosure, the processor of the wearable device may obtain information with respect to a gaze position. The operation 362 of FIG. 3B may be performed similarly to operation 320 of FIG. 3A. For example, the processor may determine or calculate a movement speed and/or direction of the gaze position, by using a sensor and/or gaze vector for detecting motion of a wearable device, such as an IMU. Based on the movement speed and/or direction of the gaze position indicated by information of the operation 362, the processor of the wearable device may selectively perform at least one of operations 364, 368, 372, and 380 of FIG. 3B.

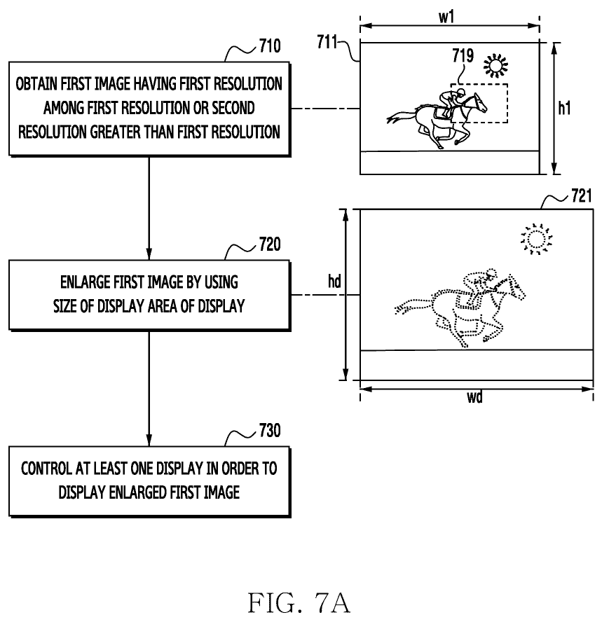

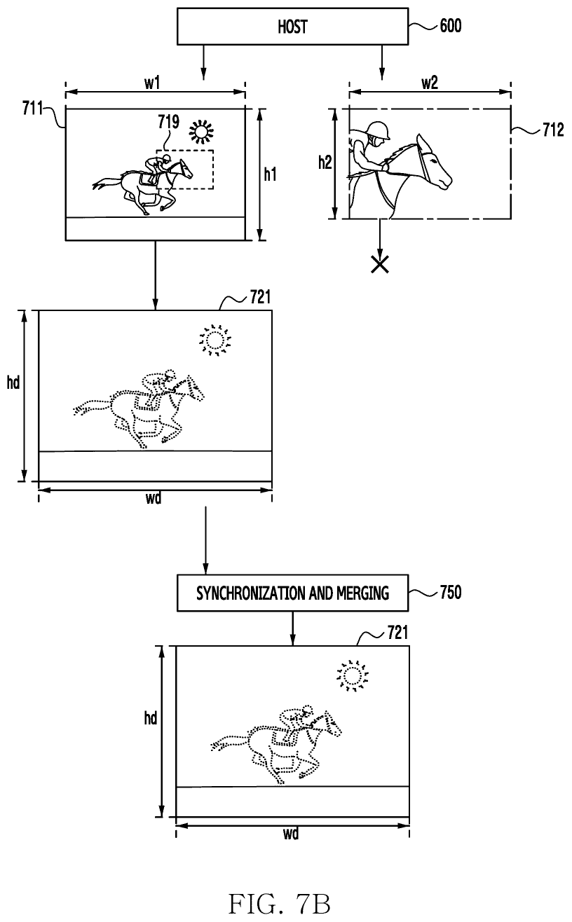

In the operation 364 of FIG. 3B, the processor of the wearable device may detect a rapid gaze movement. For example, the processor may detect a movement speed of the gaze position faster than a designated reference speed. The processor of the wearable device that detected the movement speed of the gaze position faster than the reference speed, may perform operation 366. In the operation 366, according to an embodiment of the disclosure, the processor of the wearable device may perform foveated rendering based on a first mode. The foveated rendering based on the first mode may correspond to foveated rendering of operation 332 of FIG. 3A. An operation of the wearable device performing the foveated rendering based on the first mode of the operation 366 is described with reference to FIGS. 7A and/or 7B.

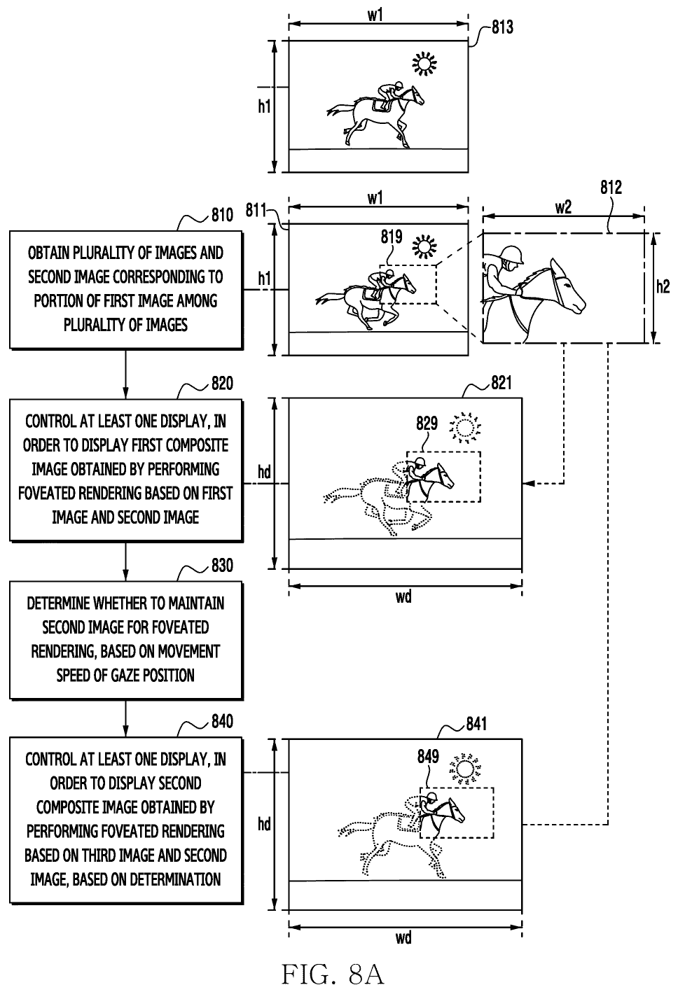

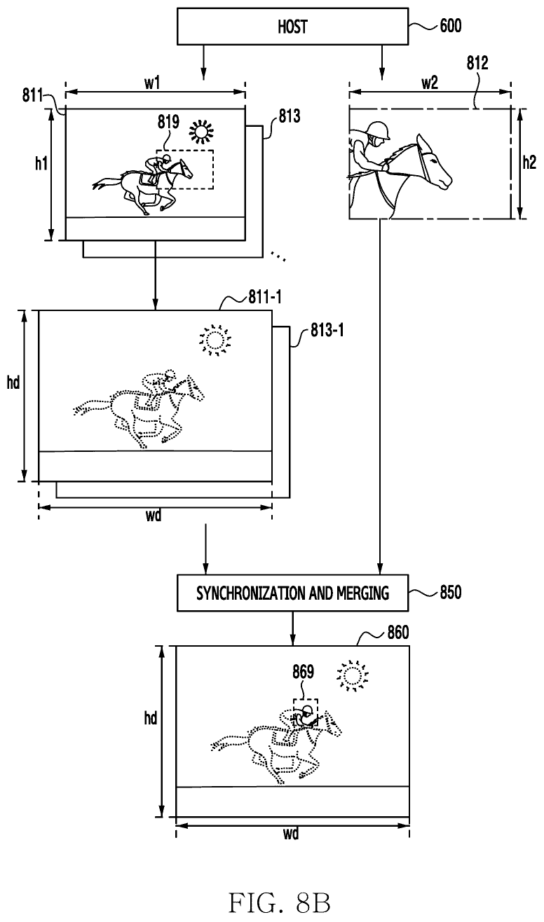

In the operation 368 of FIG. 3B, the processor of the wearable device may detect a static gaze movement. For example, the processor may detect the movement speed of the gaze position, which is slower than the designated reference speed. For example, the processor may detect the movement speed of the gaze position, which is substantially zero. In the operation 368, the processor may detect the movement speed of the gaze position, which remains substantially zero for a designated time. The processor of the wearable device that detected the static gaze movement may perform operation 370. In the operation 370, according to an embodiment of the disclosure, the processor of the wearable device may perform foveated rendering based on a second mode. The foveated rendering based on the second mode may correspond to foveated rendering of operation 350 of FIG. 3A. An operation of the wearable device performing the foveated rendering based on the second mode of the operation 370 is described with reference to FIGS. 8A and/or 8B.

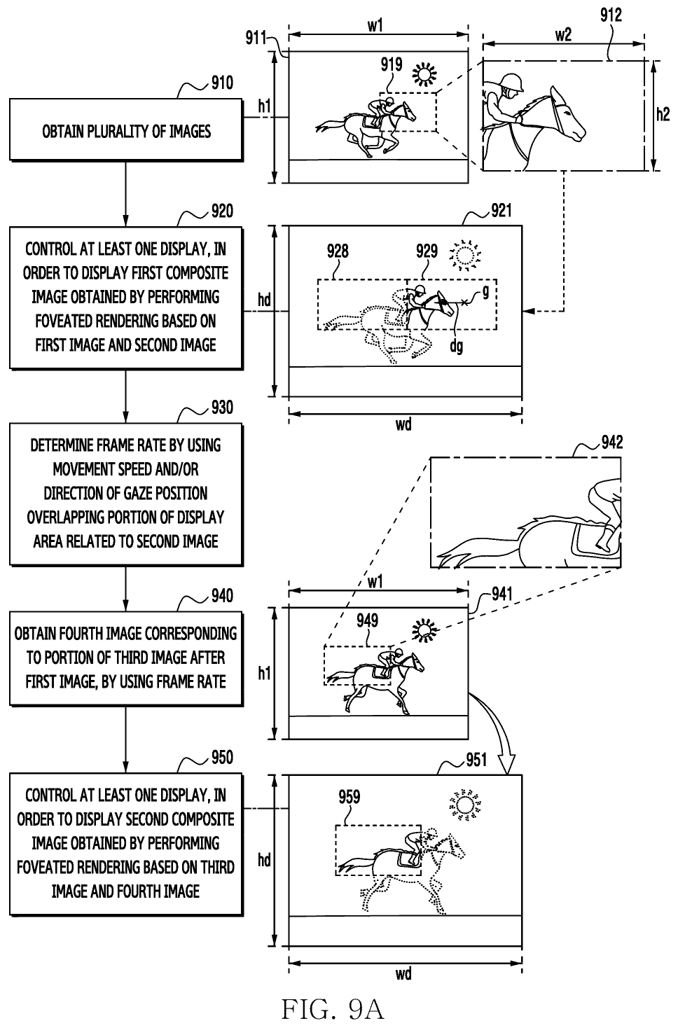

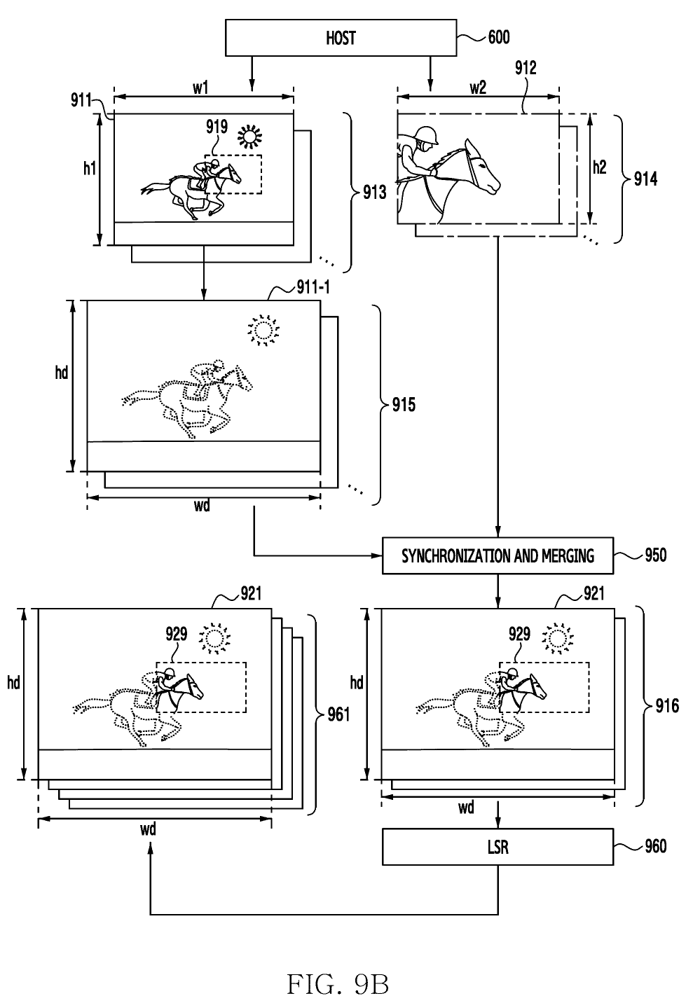

In the operation 372 of FIG. 3B, the processor of the wearable device may detect a regular gaze movement. For example, the processor may detect a movement of the gaze position according to a constant movement direction and/or a constant movement speed. The processor of the wearable device detecting the regular gaze movement of the operation 372 may perform operation 374. In the operation 374, according to an embodiment of the disclosure, the processor of the wearable device may perform foveated rendering based on a third mode. The foveated rendering based on the third mode may correspond to foveated rendering of operations 342 and 344 of FIG. 3A. An operation of the wearable device performing the foveated rendering based on the third mode of FIG. 3B is described with reference to FIGS. 9A and/or 9B.

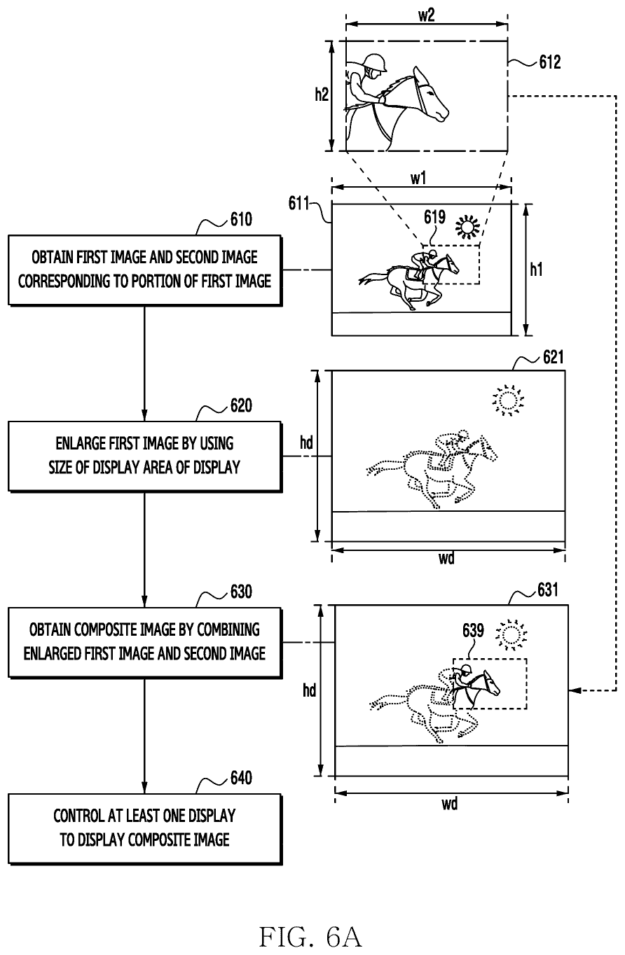

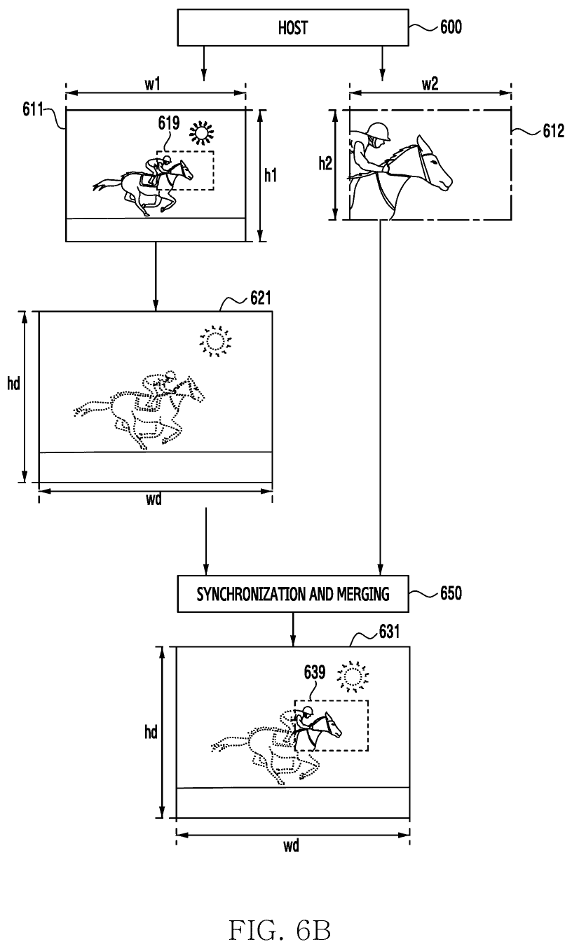

In operation 380 of FIG. 3B, the processor of the wearable device may detect a gaze movement that does not match any of conditions of the operations 364, 368, and 372. In the operation 380, the processor of the wearable device may perform operation 382. In the operation 382, according to an embodiment of the disclosure, the processor of the wearable device may perform rendering based on a default mode. An operation of the wearable device performing the foveated rendering based on the default mode of FIG. 3B is described with reference to FIGS. 6A and/or 6B.

Hereinafter, an operation of the wearable device performed to obtain information with respect to the gaze position of the operation 320 is described with reference to FIG. 4.

FIG. 4 illustrates an operation of a wearable device that determines information with respect to a gaze position according to an embodiment of the disclosure. The operation of the wearable device of FIG. 4 may be performed by a wearable device 101 of FIGS. 1 and 2A and/or a processor 210 of FIG. 2A. The operation of the wearable device of FIG. 4 may be related to at least one (e.g., operation 320) of operations of FIG. 3A.

Referring to FIG. 4, a state of the wearable device 101 worn on a head of a user 410 is illustrated. In the state of FIG. 4, the wearable device 101 may obtain information with respect to the gaze position, by using a sensor (e.g., a sensor 220 of FIG. 2A). For example, the wearable device 101 may detect motion of the head of the user 410 wearing the wearable device 101, by using a motion sensor (e.g., a motion sensor 222 of FIG. 2A). By using sensor data of the motion sensor, the wearable device 101 may obtain information indicating the motion of the head of the user 410. The information may include a vector dh indicating a direction of the wearable device 101 and/or the head of the user 410. The information may be obtained or generated based on execution of a location tracker 271 of FIG. 2A.

According to an embodiment of the disclosure, the wearable device 101 may obtain images and/or videos for two eyes (e.g., a left eye 140-1 and/or a right eye 140-2) of the user 410 wearing the wearable device 101, by using an image sensor (e.g., an image sensor 130 of FIG. 2A). For example, from a first eye tracking camera 130-1 configured to be disposed toward the left eye 140-1, the wearable device 101 may obtain an image and/or video for the left eye 140-1. From the image and/or video for the left eye 140-1, the wearable device 101 may calculate or determine a vector dl indicating a direction of the left eye 140-1. For example, from a second eye tracking camera 130-2 configured to be disposed toward the right eye 140-2, the wearable device 101 may obtain an image and/or video for the right eye 140-2. From the image and/or video for the right eye 140-2, the wearable device 101 may calculate or determine a vector dr representing a direction of the right eye 140-2. The vectors dl and dr may be obtained or generated based on execution of a gaze tracker 274 of FIG. 2A.

According to an embodiment of the disclosure, the wearable device 101 may calculate or determine information with respect to a gaze position g, by using at least one of the vectors dl, dr, and dh. The information with respect to the gaze position g may be determined based on a combination of the vectors dl, dr, and dh. For example, in case that the wearable device 101 processes the positions of a virtual object (e.g., virtual objects 421 and 422) and/or a real object by using a coordinate system linked with an external space, the wearable device 101 may determine the gaze position g in the coordinate system by using the vectors dl, dr, and dh. The wearable device 101 may determine the virtual object 421 included in a screen 120 to be displayed on a display (e.g., a display 110 of FIG. 2A), by using the coordinate system. For example, the wearable device 101 may display the virtual object 421 in the screen 120, by comparing positions v1 and v2 of the virtual objects 421 and 422 in the coordinate system and a portion in the coordinate system corresponding to the screen 120.

Referring to FIG. 4, in a state in which a first display 110-1 is disposed to cover the left eye 140-1 and a second display 110-2 is disposed to cover the right eye 140-2, a display area formed by the first display 110-1 and/or the second display 110-2 may cover or obscure the field of view of the user 410. The wearable device 101 may determine a foveated portion and a periphery portion overlapping the gaze position g, in the display area in which the screen 120 is displayed, by using the information with respect to the gaze position g. According to the movement speed of the gaze position g, the wearable device 101 may reduce a resource of the wearable device 101 occupied for rendering a high-definition image, by changing a frame rate for rendering the high-definition image with respect to the foveated portion.

Hereinafter, an operation of the wearable device 101 that changes the frame rate according to the movement speed of the gaze position g is described with reference to FIG. 5.

FIG. 5 illustrates an operation of a wearable device that determines a frame rate according to a movement speed of a gaze position according to an embodiment of the disclosure. The operation of the wearable device of FIG. 5 may be performed by a wearable device 101 of FIGS. 1 and 2A and/or a processor 210 of FIG. 2A. The operation of the wearable device of FIG. 5 may be related to at least one of operations of FIG. 3A.

Referring to FIG. 5, a graph indicating a relationship between the movement speed of the gaze position and the frame rate is illustrated. An x-axis of the graph of FIG. 5 may be related to the movement speed of the gaze position, and a y-axis may be related to the frame rate for foveated rendering. In the graph of FIG. 5, speed ranges (e.g., a first speed range 501, a second speed range 502, a third speed range 503, and a fourth speed range 504) are illustrated, which are distinguished by a first threshold speed vth1, a second threshold speed vth2, and a third threshold speed vth3. The first speed range 501 of FIG. 5 may correspond to a first speed range of operation 330 of FIG. 3A, the second speed range 502 may correspond to a second speed range of operation 340 of FIG. 3A, and the third speed range 503 may correspond to a third speed range of operation 350.

The wearable device that detected the movement speed in the first speed range 501 may perform foveated rendering based on a first mode of operation 366 of FIG. 3B. The wearable device that detected the movement speed in the third speed range 503 may perform foveated rendering based on the second mode of operation 370 of FIG. 3B. The wearable device that detected the movement speed in the second speed range 502 may perform foveated rendering based on a third mode of operation 374 of FIG. 3B. The wearable device that detected the movement speed in the fourth speed range 504 may perform foveated rendering based on a default mode of operation 382 of FIG. 3B.

Referring to FIG. 5, a line 511 may indicate a frame rate related to foveated rendering of an image having a first resolution. The image of the first resolution may be obtained to be displayed in a periphery portion and/or the entire display area of the display (e.g., a display 110 of FIG. 2A). The line 512 may indicate a frame rate related to foveated rendering of an image having a second resolution lower than the first resolution. The image of the second resolution may be obtained to be displayed on the foveated portion.

Referring to FIG. 5, while identifying the movement speed of the gaze position included in the first speed range 501 higher than the first threshold speed vth1 (or first reference speed), the processor may display an image on the entire display area of the display according to a first frame rate f1 indicated by the line 511. In the first speed range 501, the processor may perform foveated rendering based on operation 332 of FIG. 3A. For example, the processor may display the image having the first resolution, obtained according to the first frame rate f1, on the entire display area. While detecting the movement speed of the gaze position higher than the first threshold speed vth1, the processor may stop displaying another image (e.g., the image having the second resolution lower than the first resolution) different from the image having the first resolution on the foveated portion. For example, the processor may not obtain the other image different from the image having the first resolution. For example, the processor may discard the other image different from the image having the first resolution. The operation of the processor performed for the foveated rendering while detecting the movement speed of the gaze position exceeding the first threshold speed Vth1 is described with reference to FIGS. 7A and/or 7B.

Referring to FIG. 5, while identifying the movement speed of the gaze position that is lower than the first threshold speed vth1 (or the third threshold speed vth3 less than the first threshold speed vth1) and higher than the second threshold speed vth2 (or a second reference speed) (e.g., while identifying the movement speed of the gaze position included in the second speed range 502), the processor may display the image in the periphery portion according to the frame rate that is indicated by the line 511 and is lower than the first frame rate f1, and may display the image on the foveated portion according to the frame rate that is indicated by the line 512 and lower than the first frame rate f1. For example, in the second speed range 502, the frame rates indicated by the lines 511 and 512 may be changed substantially the same according to the movement speed of the gaze position. For example, in the second speed range 502, in case that the movement speed of the gaze position decreases, the frame rates used to display images on the foveated portion and the periphery portion, respectively, may decrease. For example, in the second speed range 502, in case that the movement speed of the gaze position increases, the frame rates used to display images on the foveated portion and the periphery portion, respectively, may increase.

For example, in case that the movement speed of the gaze position decreases, a period in which the gaze position is moved in a foveated portion of a specific size may increase. During the above period, the wearable device may allocate a resource to be allocated to obtain or generate a single high-resolution image in order to execute other functions, by displaying the high-resolution image in the foveated portion. When performing the foveated rendering using the single high-resolution image, the wearable device may generate or determine an image to be displayed on the display from the high-resolution image using extrapolation.

The frame rate in the second speed range 502 may be related to a direction and/or the movement speed of the gaze position detected by the wearable device. For example, in case that the gaze position moves along a specific direction with a constant movement speed (e.g., a speed change included in a designated error range and/or less than a designated deviation), the wearable device may change the frame rate according to the lines 511 and 512. For example, in case that the gaze position moves at an irregular movement speed and/or in an irregular direction, the wearable device may display the image in the foveated position and may display the image in the periphery portion, according to the frame rate (e.g., the first frame rate f1) independent of the lines 511 and 512. An operation of the wearable device that may display the image on the foveated portion and displays the image on the periphery portion according to the first frame rate f1 is described with reference to FIGS. 6A and 6B.

Referring to FIG. 5, while identifying a movement speed of the gaze position that is lower than the first threshold speed vth1 and higher than the third threshold speed vth3 (e.g., while identifying a movement speed of the gaze position included in the fourth speed range 504), the processor may display images on the periphery portion and the foveated portion according to the first frame rate f1 indicated by the lines 511 and 512. For example, in the fourth speed range 504, the frame rates indicated by the lines 511 and 512 may be maintained at a designated frame rate, such as the first frame rate f1. The first frame rate f1 may be a frame rate of a display system (e.g., a combination of a first display 110-1 and/or a second display 110-2 of FIG. 1) of the wearable device.

Referring to FIG. 5, while identifying the movement speed of the gaze position included in the third speed range 503 lower than the second threshold speed vth2, the processor may display the image on the foveated portion and may display an image on the periphery portion, according to a frame rate f2 indicated by the line 512. The embodiment is not limited thereto, and the wearable device may display the image on the periphery portion according to a frame rate higher than the frame rate f2. For example, the wearable device may maintain displaying the single high-resolution image on the foveated portion in order to maintain or help the user's focus on the foveated portion, based on detecting a static movement of the gaze position. For example, while displaying the single high-resolution image, the processor may stop or bypass further obtaining high-resolution image. For example, while displaying the single high-resolution image, the processor may discard another high-resolution image generated based on execution of a software application.

According to an embodiment of the disclosure, the wearable device may determine a size of the foveated portion as a size related to the movement speed, in response to the movement speed of the gaze position included in the second speed range 502 and/or the third speed range 503. In an embodiment of the disclosure, as the movement speed increases, the size of the foveated portion may decrease. As the movement speed decreases, the size of the foveated portion may increase. When the movement speed is increased to the first threshold speed vth1 or more, the foveated portion may be substantially removed. Using the determined size, the wearable device may obtain or generate the high-resolution image from the software application.

As described above with reference to FIG. 5, according to an embodiment of the disclosure, the wearable device may determine a level and/or mode of foveated rendering according to the movement speed of the gaze position. The wearable device may determine a parameter (e.g., image stabilizing parameter) for stabilizing an image displayed on the screen by interworking with the level (e.g., speed ranges of FIG. 5) of the foveated rendering. The parameter for stabilizing the image may include a dynamic parameter and/or a static parameter. The dynamic parameter may be changed or determined according to the movement speed and/or the movement direction of the gaze position.

Hereinafter, operations of the wearable device that determines the frame rate in each of the speed ranges (e.g., the first speed range 501, the second speed range 502, and the third speed range 503) are described with reference to FIGS. 6A, 6B, 7A, 7B, 8A, 8B, 9A, and 9B.

FIGS. 6A and 6B illustrate flowcharts for an operation of a wearable device related to foveated rendering according to various embodiments of the disclosure. A wearable device 101 of FIGS. 1 and/or 2A and/or a processor 210 of FIG. 2A may perform at least one of operations of FIG. 6A. For example, at least some operation among the operations of FIG. 6A may be performed by a wearable device that executed a foveated renderer 290 of FIG. 2A. For example, at least some operation among the operations of FIG. 6A may be performed by the processor 210 and/or a DPU 213 of FIG. 2A. The operation of FIG. 6A may be related to at least one of operations of FIG. 3A. An order in which the operations of FIG. 6A are performed is not limited to an order illustrated in FIG. 6A. For example, the processor of the wearable device may perform the operations of FIG. 6A in an order different from the order illustrated in FIG. 6A. For example, the processor of the wearable device may perform at least two operations among the operations of FIG. 6A substantially simultaneously.

Referring to FIG. 6A, in operation 610, according to an embodiment of the disclosure, the processor of the wearable device may obtain a first image 611 and a second image 612 corresponding to a portion 619 of the first image 611. The portion 619 may correspond to a foveated portion (e.g., a portion 129 of FIG. 1) in a display area overlapping a gaze position. A width w1 and a height h1 of the first image 611 may be smaller than a width wd and a height hd of the entire display area of a display (e.g., a display 110 of FIG. 2A), respectively. A width w2 and a height h2 of the second image 612 may be smaller than the width and height of the entire display area of the display, respectively. The width w2 and the height h2 of the second image 612 may match to the width w1 and the height h1 of the first image 611, respectively. A first resolution of the first image 611 may be lower than a second resolution of the second image 612.

Referring to FIG. 6A, in operation 620, according to an embodiment of the disclosure, the processor of the wearable device may enlarge the first image 611 by using the size of the display area of the display. Referring to FIG. 6A, an enlarged first image 621 is illustrated. The processor may enlarge the first image 611 to have the width wd and the height hd of the entire display area of the display, by using upscaling. The enlarged first image 621 may have a resolution lower than the first resolution of the first image 611.

Referring to FIG. 6A, in operation 630, according to an embodiment of the disclosure, the processor of the wearable device may obtain a composite image 631 by combining the enlarged first image 621 and the second image 612. The second image 612 may be synthesized on a portion of the synthesized image 621 that is mapped to the portion 619 of the first image 611 corresponding to the second image 612. Referring to FIG. 6A, the composite image 631 obtained by performing the operation 630 is exemplarily illustrated. A portion 639 of the composite image 631 may correspond to the portion 619 of the first image 611. For example, a position in the composite image 631 of the portion 639 to which the second image 612 is combined may correspond to the position in the first image 611 of the portion 619. In other words, the portion 639 of the composite image 631 may correspond to the foveated portion. The position of the portion 639 in the composite image 631 may correspond to the gaze position in the display area, or may include the gaze position in the display area. For example, the processor may lower visibility of a boundary line between the second image 612 and the enlarged first image 621 by using a visual effect, such as blur.

Referring to FIG. 6A, in operation 640, according to an embodiment of the disclosure, the processor of the wearable device may control at least one display to display the composite image 631. Since the width wd and the height hd of the composite image 631 correspond to the width and height of the entire display area, the processor may display the composite image 631 through the entire display area. The portion 639 of the composite image 631 to which the second image 612 of the second resolution lower than the first resolution of the first image 611 is combined may have a resolution higher than another portion. Thus, when the display is controlled to display the composite image 631, a resolution of the foveated portion (e.g., the portion 639) may be higher than a resolution of the periphery portion.

Referring to FIG. 6B, foveated rendering performed by a processor, such as the DPU 213 of FIG. 2A is exemplarily illustrated. The DPU may obtain the first image 611 and the second image 612 corresponding to the portion 619 of the first image 611, from a host 600 including the application processor (e.g., a CPU 211 of FIG. 2A). The host 600 may include a software application executed by a processor as well as the processor, such as the application processor. The DPU may generate or obtain the enlarged first image 621, by enlarging the first image 611 based on upscaling. The DPU may combine the enlarged first image 621 and the second image 612, by performing a synchronization and merging operation 650. Based on the combination, the DPU may generate the composite image 631. The composite image 631 may have a shape in which at least a portion of the second image 612 is overlapped on the enlarged first image 621. For example, the second image 612 may be located on the portion 639 of the composite image 631. The DPU may control the display system in order to display the composite image 631.

FIGS. 7A and 7B illustrate flowcharts for an operation of a wearable device that detected a gaze position moving at a movement speed in a first speed range 501 of FIG. 5 according to various embodiments of the disclosure. A wearable device 101 of FIGS. 1 and/or 2A and/or a processor 210 of FIG. 2A may perform at least one of operations of FIG. 7A. For example, at least some operation among the operations of FIG. 7A may be performed by a wearable device that executed a foveated renderer 290 of FIG. 2A. For example, at least some operation among the operations of FIG. 7A may be performed by the processor 210 and/or a DPU 213 of FIG. 2A. The operation of FIG. 7A may be related to at least one (e.g., operation 332) of operations of FIG. 3A. An order in which the operations of FIG. 7A are performed is not limited to an order illustrated in FIG. 7A. For example, the processor of the wearable device may perform the operations of FIG. 7A in an order different from the order illustrated in FIG. 7A. For example, the processor of the wearable device may perform at least two operations among the operations of FIG. 7A substantially simultaneously.

When a user wearing the wearable device moves own head rapidly or moves own gaze, distortion (e.g., blur) in the foveated portion may occur, due to foveated rendering with respect to the foveated portion. In order to reduce the distortion, according to an embodiment of the disclosure, the wearable device may perform foveated rendering based on a low-resolution image (e.g., a first image 711 of FIGS. 7A and/or 7B) without a high-resolution image.

Referring to FIG. 7A, in operation 710, according to an embodiment of the disclosure, the processor of the wearable device may obtain the first image 711 having a first resolution among the first resolution or a second resolution greater than the first resolution. The first image 711 may be obtained from a software application executed by the wearable device, in order to display the entire display area and/or a periphery portion of a display (e.g., a display 110 of FIG. 2A). For example, a width w1 and a height h1 of the first image 711 may be smaller than a width wd and a height hd of the entire display area of the display, respectively.

Referring to FIG. 7A, in operation 720, according to an embodiment of the disclosure, the processor of the wearable device may enlarge the first image 711. by using the size of the display area of the display (e.g., upscaling). For example, the processor may enlarge the first image 711, based on a setting value of the software application (e.g., the upscaling). For example, the processor may increase the width w1 of the first image 711 to the width wd of the entire display area and the height h1 of the first image 711 to the height hd of the entire display area, by using the upscaling. Referring to FIG. 7A, an enlarged first image 721 based on the operation 720 is illustrated. The enlarged first image 721 may have a resolution lower than or equal to the first resolution of the first image 711.

Referring to FIG. 7A, in operation 730, according to an embodiment of the disclosure, the processor of the wearable device may control at least one display in order to display the enlarged first image 721. The processor may control at least one display, in order to fill the enlarged first image 721 in the entire display area.

As described above with reference to FIGS. 3A and/or 5, the processor may perform the operations of FIG. 7A in case that detecting a first threshold speed and/or a movement speed of a gaze position higher than a first reference speed. The processor performing the operations of FIG. 7A may control the display by using only the first image 711, without obtaining any image corresponding to a portion 719 of the first image 711 corresponding to the foveated portion (e.g., another image having a resolution higher than the first resolution of the first image 711). In case that the gaze position is rapidly moved, motion blur according to the rapid movement of the gaze position may occur in the high-resolution image. In order not to visualize the motion blur included in the high-resolution image, the processor may control the display by using only the low-resolution image among the low-resolution image and the high-resolution image, as described above with reference to FIG. 7A.

Referring to FIG. 7B, foveated rendering performed by a processor, such as the DPU 213 of FIG. 2A is exemplarily illustrated. The DPU may obtain the first image 711 and a second image 712 corresponding to the portion 719 of the first image 711, from a host 600 including an application processor (e.g., a CPU 211 of FIG. 2A). The DPU may generate or obtain the enlarged first image 721, by enlarging the first image 711 based on the upscaling. Referring to FIG. 7B, the DPU may perform a synchronization and merging operation 750 without the second image 712. The DPU may control a display system, in order to display the enlarged first image 721. For example, for the synchronization and merging operation 750, only the enlarged first image 721 may be used among the enlarged first image 721 and the second image 712. The DPU may upscale the enlarged first image 721, and may display the upscaled enlarged first image 721.

FIGS. 8A and 8B illustrate flowcharts for an operation of a wearable device that detected a gaze position moving at a movement speed in a third speed range 503 of FIG. 5 according to various embodiments of the disclosure. A wearable device 101 of FIGS. 1 and/or 2A and/or a processor 210 of FIG. 2A may perform at least one of operations of FIG. 8A. For example, at least some operation among the operations of FIG. 8A may be performed by a wearable device that executed a foveated renderer 290 of FIG. 2A. For example, at least some operation among the operations of FIG. 8A may be performed by the processor 210 and/or a DPU 213 of FIG. 2A. The operation of FIG. 8A may be related to at least one (e.g., operation 350) of operations of FIG. 3A. An order in which the operations of FIG. 8A are performed is not limited to an order illustrated in FIG. 8A. For example, the processor of the wearable device may perform the operations of FIG. 8A in an order different from the order illustrated in FIG. 8A. For example, the processor of the wearable device may perform at least two operations among the operations of FIG. 8A substantially simultaneously.

Referring to FIG. 8A, in operation 810, according to an embodiment of the disclosure, the processor of the wearable device may obtain a plurality of images and a second image 812 corresponding to a portion 819 of a first image 811 among the plurality of first images. The plurality of images may include downscaled images (e.g., the first image 811 and/or a third image 813). The portion 819 may correspond to a foveated portion in a display area. The second image 812 corresponding to the portion 819 may be a high-resolution single foveated image used for foveated rendering. A width w1 and a height h1 of the first image 811 may be smaller than a width wd and a height hd of the entire display area of a display (e.g., a display 110 of FIG. 2A), respectively. A width w1 and a height h1 of the first image 811 may be smaller than a width and a height of a source image corresponding to the first image 811, respectively. A resolution of the first image 811 may be lower than a resolution of the source image. A width w2 and a height h2 of the second image 812 may be smaller than a width and a height of the entire display area of the display, respectively. The width w2 and the height h2 of the second image 812 may match to the width w1 and the height h1 of the first image 811, respectively. A first resolution of the first image 811 may be lower than a second resolution of the second image 812.

Referring to FIG. 8A, in operation 820, according to an embodiment of the disclosure, the processor of the wearable device may control at least one display, in order to display a first composite image 821 obtained by performing foveated rendering based on the first image 811 and the second image 812. The operation 820 of FIG. 8A for generating the first composite image 821 may be performed similarly to operations 620, 630, and 640 of FIG. 6A. For example, the processor may enlarge the first image 811 according to a size of the entire display area. By combining the second image 812 on the enlarged first image 811, the processor may obtain or generate the first composite image 821. In the first composite image 821, the second image 812 may have a position based on the position of the portion 819 in the first image 811 and/or the portion 829 corresponding to the foveated portion. While displaying the first composite image 821, a user wearing the wearable device 101 may clearly view the second image 812 through the portion 829 corresponding to the foveated portion. When enlarging a plurality of images including the first image 811, the processor may not enlarge the second image 812. For example, a size and/or a resolution of the second image 812 may be maintained while performing the foveated rendering.

Referring to FIG. 8A, in operation 830, according to an embodiment of the disclosure, the processor of the wearable device may determine whether to maintain the second image 812 for the foveated rendering, based on the movement speed of the gaze position. For example, in case that the movement speed of the gaze position is included in a relatively slow speed range (e.g., a third speed range 503 of FIG. 5), the processor may determine to keep the second image 812 for the foveated rendering. In case of determining to keep the second image 812 for the foveated rendering, the processor may perform operation 840. In case of determining to keep the second image 812 for the foveated rendering, the processor may not obtain another image after the second image 812 having the second resolution higher than the first resolution.

Referring to FIG. 8A, in operation 840, according to an embodiment of the disclosure, the processor of the wearable device may control at least one display, in order to display a second composite image 841 obtained by performing the foveated rendering based on a third image 831 and the second image 812, based on the determination of the operation 830. For example, the processor may enlarge the third image 831 according to the size of the entire display area. The processor may generate or obtain the second composite image 841, by combining the second image 812 on the enlarged third image 831 having the width wd and the height hd of the entire display area. In the second composite image 841, the second image 812 may be located on a portion 849 corresponding to the foveated portion. While displaying the second composite image 841, the user wearing the wearable device 101 may continue to view the second image 812 through the portion 849 corresponding to the foveated portion.

As described above with reference to FIG. 3A and/or FIG. 5, the processor may perform the operations of FIG. 8A, in case of detecting the movement speed of the gaze position, which is lower than a second threshold speed. The processor performing the operations of FIG. 8A may display a single image (e.g., the second image 812) on the foveated portion and may change an image (e.g., the first image 811) displayed on a periphery portion. For example, a frame rate corresponding to the foveated portion may be substantially reduced to zero. Since the processor performs the foveated rendering by using a single high-resolution image, a resource (e.g., memory bandwidth) occupied to obtain the high-resolution image may be reduced. In frames displayed on the display along a refresh rate, the second image 812 may continue to be displayed.

Referring to FIG. 8B, foveated rendering performed by a processor, such as the DPU 213 of FIG. 2A is exemplarily illustrated. The DPU may obtain a plurality of images (e.g., the first image 811, the third image 813) including the first image 811 downscaled from the source image, from a host 600 including an application processor (e.g., a CPU 211 of FIG. 2A). The DPU may obtain the second image 812 corresponding to the portion 819 of the first image 811 from the host 600.

The DPU may generate or obtain an enlarged first image 811-1 and an enlarged third image 813-1 by enlarging each of the first image 811 and the third image 813 based on upscaling. Referring to FIG. 8B, the DPU may perform a synchronization and merging operation 850 of combining the second image 812 to each of the enlarged images (e.g., the enlarged first image 811-1 and the enlarged third image 813-1). Using the synchronization and merging operation 850, at least a portion of the second image 812 may be combined on the enlarged first image 811-1. For example, a portion of the second image 812 may be located on a portion 869 of a composite image 860 generated from the enlarged first image 811-1. The DPU may control a display system, in order to display the composite image 860. The second image 812 may be combined on the enlarged first image 811-1 and/or the enlarged third image 813-1 without an enlargement operation, such as the upscaling.

FIGS. 9A and 9B illustrate flowcharts for an operation of a wearable device that detected a gaze position moving at a movement speed in a second speed range 502 of FIG. 5 according to various embodiments of the disclosure. A wearable device 101 of FIGS. 1 and/or 2A and/or a processor 210 of FIG. 2A may perform at least one of operations of FIG. 9A. For example, at least some operation among the operations of FIG. 9A may be performed by a wearable device that executed a foveated renderer 290 of FIG. 2A. For example, at least some operation among the operations of FIG. 9A may be performed by the processor 210 and/or a DPU 213 of FIG. 2A. The operation of FIG. 9A may be related to at least one (e.g., operations 342 and 344) of operations of FIG. 3A. An order in which the operations of FIG. 9A are performed is not limited to an order illustrated in FIG. 9A. For example, the processor of the wearable device may perform the operations of FIG. 9A in an order different from the order illustrated in FIG. 9A. For example, the processor of the wearable device may perform at least two operations among the operations of FIG. 9A substantially simultaneously.

Referring to FIG. 9A, in operation 910, according to an embodiment of the disclosure, the processor of the wearable device may obtain a plurality of images. The plurality of images may obtain scaled-down images (e.g., a first image 911 and a third image 941) and images (e.g., a second image 912 and a fourth image 942) corresponding to a foveated portion.

Referring to FIG. 9A, in operation 920, according to an embodiment of the disclosure, the processor of the wearable device may control at least one display (e.g., a display 110 of FIG. 2A), in order to display a first composite image 921 obtained by performing foveated rendering based on the first image 911 and a second image 912. The second image 912 may correspond to a portion 919 of the first image 911. The operation 920 performed by the processor to obtain the first composite image 921 may be performed similarly to operation 820 of FIG. 8A. For example, the first composite image 921 may include a portion 929 corresponding to the foveated portion. The first composite image 921 may include the first image 911 enlarged according to a size of the entire display area. The embodiment is not limited thereto, and the first composite image 921 may have a size defined by a size (e.g., a size of the display and/or a size predetermined by a software application executed by the processor) larger than a size of the first image 911. The second image 912 may be combined to the portion 929 of the first composite image 921.

In an embodiment of the disclosure, while controlling at least one display by using the first composite image 921, the processor may generate or display an intermediate image between the first composite image 921 and a composite image that was displayed before the first composite image 921, by performing frame extrapolation based on late stage restoration (LSR).

Referring to FIG. 9A, in operation 930, according to an embodiment of the disclosure, the processor of the wearable device may determine a frame rate by using a movement speed and/or direction dg of a gaze position g overlapping a portion of the display area related to the second image 912. In response to the movement speed of the gaze position g included in a second speed range (e.g., the second speed range 502 of FIG. 5), the processor may determine the frame rate such that the update of the second image 912 is performed, when the gaze position g reaches a boundary of the portion of the display area in which the second image 912 is displayed.

For example, the processor may change or determine the frame rate, in order to maintain displaying the second image 912 based on the first composite image 921, while the gaze position g is included in the portion of the display area in which the second image 912 is displayed. For example, while the gaze position g moves along the direction dg in the portion 929 of the first composite image 921 to which the second image 912 is combined, the processor may maintain controlling the display by using the first composite image 921 including the second image 912. For example, until the gaze position g reaches a boundary line between the portion 929 and another portion 928 along the direction dg, the processor may maintain controlling the display by using the first composite image 921 including the second image 912.

Referring to FIG. 9A, in operation 940, according to an embodiment of the disclosure, the processor of the wearable device may obtain the fourth image 942 corresponding to a portion 949 of the third image 941 after the first image 911, by using the frame rate of the operation 930. The third image 941 may have a width w1 smaller than a width of the entire display area and a height h1 smaller than a height of the entire display area. Each of the third image 941 and the fourth image 942 may have the same dimensions (e.g., width and/or height) as the first image 911 and the second image 912. The processor may obtain the third image 941 and the fourth image 942 according to the frame rate that is determined by the operation 930. For example, according to a frame rate proportional to the movement speed of the gaze position, the processor may obtain the third image 931 and the fourth image 942.

Referring to FIG. 9A, the third image 941 and the fourth image 942 obtained by the processor that performed the operation 940 are exemplarily illustrated. The processor may determine the portion 949 of the third image 941 corresponding to the other portion 928 that the gaze position g has reached in the first composite image 921. For example, the portion 949 may correspond to or include a gaze position overlapping the display area. The portion 949 may be adjacent to the portion 919 of the first image 911 along the direction dg of the gaze position g or may have a position next to the portion 919. In the first composite image 921, the portion 928 corresponding to the portion 949 of the third image 941 may be located next to the portion 929 corresponding to the portion 919 of the first image 911, according to the direction dg in which the gaze position g is moved.

Referring to FIG. 9A, in operation 950, according to an embodiment of the disclosure, the processor of the wearable device may control at least one display, in order to display a second composite image 951 obtained by performing the foveated rendering based on the third image 941 and the fourth image 942. The processor may perform the operation 950 similarly to operations 620, 630, and 640 of FIG. 6A, by using the third image 941 and the fourth image 942. For example, the processor may enlarge the third image 941 according to the size of the entire display area. The processor may generate or obtain the second composite image 951 by combining the fourth image 942 on the enlarged portion 949 in the enlarged third image 941. The processor may control at least one display, in order to fill the entire display area with the second composite image 951.

Referring to FIG. 9B, foveated rendering performed by a processor, such as the DPU 213 of FIG. 2A is exemplarily illustrated. The DPU may obtain a first set 913 of a plurality of images including the first image 911 downscaled from the source image, from a host 600 including an application processor (e.g., a CPU 211 of FIG. 2A). The DPU may obtain the second image 912 corresponding to the portion 919 of the first image 911 from the host 600. The DPU may obtain a second set 914 of a plurality of images corresponding to the foveated portion, such as the second image 912, from the host 600.

The DPU may obtain a third set 915 of enlarged images by enlarging a plurality of images (e.g., the first image 911) included in the first set 913 based on upscaling. Referring to FIG. 9B, the third set 915 may include an enlarged first image 911-1. A width wd and a height hd of the first image 911-1 may be determined by an attribute set for the upscaling. The attribute may be related to the size of the display and/or display area of the wearable device. The attribute may be related to the software application executed by the wearable device.

The DPU may perform a synchronization and merging operation 950 in which the images included in the second set 914 are combined with the enlarged images included in the third set 915, respectively. Based on the synchronization and merging operation 950, the DPU may obtain a fourth set 916 of composite images. By using the synchronization and merging operation 950, the second image 912 may be combined on the enlarged first image 911-1. For example, the second image 912 may be located on the portion 929 of the composite image 921 included in the fourth set 916. As described above with reference to FIG. 9A, since the frame rate is changed, the DPU may obtain or generate the fourth set 916 of the composite images, according to the changed frame rate.

The DPU may obtain a fifth set 961 of composite images based on the frame rate of the display, by performing extrapolation based on a LSR 960 with respect to the fourth set 916 of the composite image. The fifth set 961 may further include an intermediate image based on the frame rate of the display as well as the composite image 921 included in the fourth set 916. The DPU may control the display of the wearable device, in order to display the composite images of the fifth set 961.

As described above, according to an embodiment of the disclosure, the wearable device may at least temporarily stop performing the foveated rendering using a high-resolution image, or may change the frame rate at which the foveated rendering is performed using the high-resolution image. The wearable device may change the frame rate at which the foveated rendering is performed using the high-resolution image, according to the movement speed and/or direction of the gaze position. For example, in order to reduce the resources occupied to perform the foveated rendering using the high-resolution image, the processor may change the frame rate according to the movement speed of the gaze position.

Hereinafter, an appearance of the wearable device 101 described with reference to FIGS. 1, 2A, 2B, 3A, 3B, 4, 5, 6A, 6B, 7A, 7B, 8A, 8B, and 9A is illustrated with reference to FIGS. 10A and/or 10B. A wearable device 1000 of FIGS. 10A and/or 10B may be an example of the wearable device 101 of FIG. 1.

FIGS. 10A and 10B illustrate an exterior of a wearable device according to various embodiments of the disclosure. A wearable device 1000 of FIGS. 10A and 10B may include at least a portion of hardware of the wearable device 1000 described with reference to FIGS. 1 and/or 2A. According to an embodiment of the disclosure, an example of an exterior of a first surface 1010 of a housing of the wearable device 1000 may be illustrated in FIG. 10A, and an example of an exterior of a second surface 1020 opposite to the first surface 1010 may be illustrated in FIG. 10B.

Referring to FIG. 10A, according to an embodiment of the disclosure, the first surface 1010 of the wearable device 1000 may have a form attachable on a user's body part (e.g., the user's face). Although not illustrated, the wearable device 1000 may further include a strap and/or one or more temples for being fixed on the user's body part. A first display 1050-1 for outputting an image to a left eye among the user's two eyes and a second display 1050-2 for outputting an image to a right eye among the two eyes may be disposed on the first surface 1010. The wearable device 1000 may further include rubber or silicon packing, which are formed on the first surface 1010, for preventing interference by light (e.g., ambient light) different from light emitted from the first display 1050-1 and the second display 1050-2. The first display 1050-1 and the second display 1050-2 may correspond to a first display 110-1 and a second display 110-2 of FIG. 1, respectively.

According to an embodiment of the disclosure, the wearable device 1000 may include cameras 1060-1 for photographing and/or tracking two eyes of the user adjacent to each of the first display 1050-1 and the second display 1050-2. The cameras 1060-1 may correspond to an eye tracking camera (e.g., a first eye tracking camera 130-1 and/or a second eye tracking camera 130-2) of FIG. 1. According to an embodiment of the disclosure, the wearable device 1000 may include cameras 1060-5 and 1060-6 for photographing and/or recognizing the user's face. The cameras 1060-5 and 1060-6 may be referred to as a FT camera. The wearable device 1000 may control an avatar representing the user in the virtual space, based on the motion of the user's face identified using the cameras 1060-5 and 1060-6. For example, the wearable device 1000 may change the texture and/or shape of a portion (e.g., a portion of an avatar representing a human face) of the avatar, by using information obtained by the cameras 1060-5 and 1060-6 (e.g., the FT camera) and indicating the facial expression of the user wearing the wearable device 1000.

Referring to FIG. 10B, a camera (e.g., cameras 1060-7, 1060-8, 1060-9, 1060-10, 1060-11, and 1060-12) and/or a sensor (e.g., a depth sensor 1030) for obtaining information related to an external environment of the wearable device 1000 may be disposed on the second surface 1020 opposite to the first surface 1010 of FIG. 10A. For example, the cameras 1060-7, 1060-8, 1060-9, and 1060-10 may be disposed on the second surface 1020, in order to recognize an external object.

For example, by using the cameras 1060-11 and 1060-12, the wearable device 1000 may obtain an image and/or video to be transmitted to each of the user's two eyes. The camera 1060-11 may be disposed on the second surface 1020 of the wearable device 1000 to obtain an image to be displayed through the second display 1050-2 corresponding to the right eye among the two eyes. The camera 1060-12 may be disposed on the second surface 1020 of the wearable device 1000 to obtain an image to be displayed through the first display 1050-1 corresponding to the left eye among the two eyes.

According to an embodiment of the disclosure, the wearable device 1000 may include a depth sensor 1030 disposed on the second surface 1020 in order to identify a distance between the wearable device 1000 and the external object. By using the depth sensor 1030, the wearable device 1000 may obtain spatial information (e.g., a depth map) for at least a portion of a field of view (FoV) of the user wearing the wearable device 1000. Although not illustrated, a microphone for obtaining a sound outputted from the external object may be disposed on the second surface 1020 of the wearable device 1000. The number of microphones may be one or more according to the embodiment.

In an embodiment of the disclosure, a method of reducing or/or optimizing a resource occupied for foveated rendering may be required. In an embodiment of the disclosure, a method of changing a frame rate for obtaining an image for the foveated rendering according to a movement speed of a gaze position may be required. As described above, according to an embodiment of the disclosure, a wearable device (e.g., a wearable device 101 of FIG. 1, a wearable device 1000 of FIG. 10A and/or 10B) may comprise a display system including a first display and a second display which are configured to be respectively positioned toward eyes of a user wearing the wearable device, at least one sensor (e.g., a sensor 220 of FIG. 2A), at least one processor (e.g., a processor 210 of FIG. 2A) comprising processing circuitry, and memory (e.g., memory 215 of FIG. 2A), comprising one or more storage mediums, storing instructions. The instructions, when executed by the at least one processor individually and/or collectively, may cause the wearable device to obtain information with respect to a gaze position by using the at least one sensor. The instructions, when executed by the at least one processor individually and/or collectively, may cause the wearable device to, based on identifying a movement speed of the gaze position slower than a reference speed using the information, obtain a plurality of first images corresponding to a display area of the display system. The instructions, when executed by the at least one processor individually and/or collectively, may cause the wearable device to obtain a second image corresponding to a foveated area that is specified within the display area based on the gaze position. The instructions, when executed by the at least one processor individually and/or collectively, may cause the wearable device to perform foveated rendering with respect to a screen to be displayed through the display area by combining the second image to each of the plurality of first images that is upscaled based on a size of the display area.

For example, the reference speed may be a first reference speed. The instructions, when executed by the at least one processor individually and/or collectively, may cause the wearable device to, based on identifying that the movement speed of the gaze position that is faster than the first reference speed and slower than a second reference speed higher than the first reference speed, identify whether the movement speed and a movement direction of the gaze position are maintained. The instructions, when executed by the at least one processor individually and/or collectively, may cause the wearable device to, based on identifying that the movement speed and the movement direction are maintained, determine a frame rate corresponding to the movement speed and being included in a range lower than a reference frame rate of the display system. The instructions, when executed by the at least one processor individually and/or collectively, may cause the wearable device to obtain the plurality of first images corresponding to the display area of the display system according to the frame rate. The instructions, when executed by the at least one processor individually and/or collectively, may cause the wearable device to obtain a plurality of third images corresponding to the foveated area according to the frame rate. The instructions, when executed by the at least one processor individually and/or collectively, may cause the wearable device to combine, to each of the plurality of first images that is upscaled based on a size of the display area, each of the plurality of third images. The instructions, when executed by the at least one processor individually and/or collectively, may cause the wearable device to perform foveated rendering with respect to the screen to be displayed through the display area by performing extrapolation of combinations of the plurality of first images and the plurality of third images according to a difference between the reference frame rate and the frame rate.

For example, the instructions, when executed by the at least one processor individually and/or collectively, may cause the wearable device to obtain the plurality of third images which are arranged along the movement direction within the display area.

For example, the instructions, when executed by the at least one processor individually and/or collectively, may cause the wearable device to determine the frame rate such that, while the gaze position overlap the foveated area corresponding to a fourth image of the plurality of third images, the foveated rendering based on the fourth image corresponding to the foveated area is performed.

For example, the instructions, when executed by the at least one processor individually and/or collectively, may cause the wearable device to, based on identifying the movement speed of the gaze position faster than the first reference speed and slower than the second reference speed, determine sizes of the plurality of third images according to the movement speed.

For example, the instructions, when executed by the at least one processor individually and/or collectively, may cause the wearable device to, based on identifying changing of at least one of the movement speed or the movement direction, obtain the plurality of first images and the plurality of third images according to the reference frame rate among the frame rate and the reference frame rate.

For example, the reference speed may be a first reference speed. The instructions, when executed by the at least one processor individually and/or collectively, may cause the wearable device to, based on identifying the movement speed of the gaze position faster than a second reference speed higher than the first reference speed, obtain the plurality of first images corresponding to the display area of the display system. The instructions, when executed by the at least one processor individually and/or collectively, may cause the wearable device to perform the foveated rendering with respect to the screen using the plurality of first images upscaled based on the size of the display area such that portions of the plurality of first images are located at the foveated area.

For example, the instructions, when executed by the at least one processor individually and/or collectively, may cause the wearable device to obtain the plurality of first images having sizes smaller than a size of the entire display area.

For example, the instructions, when executed by the at least one processor individually and/or collectively, may cause the wearable device to obtain the information using sensor data of the at least one sensor comprising an image sensor (e.g., an image sensor 130 of FIG. 1) configured to be positioned toward an eye of a user, and a motion sensor (e.g., a motion sensor 222 of FIG. 2A) configured to detect motion of the wearable device.

For example, the instructions, when executed by the at least one processor individually and/or collectively, may cause the wearable device to update the second image to be used for the foveated rendering based on identifying that the gaze position overlaps a portion of the display area corresponding to a boundary of the second image.

As described above, according to an embodiment of the disclosure, a method of a wearable device may be provided. The wearable device may comprise a display system including a first display and a second display which are configured to be respectively positioned toward eyes of a user wearing the wearable device and at least one sensor. The method may comprise obtaining information with respect to a gaze position by using the at least one sensor. The method may comprise, based on identifying a movement speed of the gaze position slower than a reference speed using the information, obtaining a plurality of first images corresponding to a display area of the display system. The method may comprise obtaining a second image corresponding to a foveated area that is specified within the display area based on the gaze position. The method may comprise performing foveated rendering with respect to a screen to be displayed through the display area by combining the second image to each of the plurality of first images that is upscaled based on a size of the display area.

For example, the reference speed may be a first reference speed. The method may comprise, based on identifying that a movement speed of the gaze position faster than the first reference speed and slower than a second reference speed higher than the first reference speed, identifying whether the movement speed and a movement direction of the gaze position are maintained. The method may comprise, based on identifying that the movement speed and the movement direction are maintained, determining a frame rate corresponding to the movement speed and being included in a range lower than a reference frame rate of the display system. The method may comprise obtaining the plurality of first images corresponding to the display area of the display system according to the frame rate. The method may comprise obtaining a plurality of third images corresponding to the foveated area according to the frame rate. The method may comprise combining, to each of the plurality of first images that is upscaled based on a size of the display area, each of the plurality of third images. The method may comprise performing foveated rendering with respect to the screen to be displayed through the display area by performing extrapolation of combinations of the plurality of first images and the plurality of third images according to a difference between the reference frame rate and the frame rate.

For example, the obtaining the plurality of third images may comprise obtaining the plurality of third images which are arranged along the movement direction within the display area.

For example, the determining the frame rate may comprise determining the frame rate such that, while the gaze position overlap the foveated area corresponding to a fourth image of the plurality of third images, the foveated rendering based on the fourth image corresponding to the foveated area is performed.

For example, the method may comprise, based on identifying the movement speed of the gaze position faster than the first reference speed and slower than the second reference speed, determining sizes of the plurality of third images according to the movement speed.

For example, the obtaining the plurality of third images may comprise, based on identifying changing of at least one of the movement speed or the movement direction, obtaining the plurality of first images and the plurality of third images according to the reference frame rate among the frame rate and the reference frame rate.

For example, the reference speed may be a first reference speed. The method may comprise, based on identifying the movement speed of the gaze position faster than a second reference speed higher than the first reference speed, obtaining the plurality of first images corresponding to the display area of the display system. The method may comprise, performing the foveated rendering with respect to the screen using the plurality of first images upscaled based on the size of the display area such that portions of the plurality of first images are located at the foveated area.

For example, the obtaining the plurality of first images may comprise obtaining the plurality of first images having sizes smaller than a size of the entire display area.

As described above, according to an embodiment of the disclosure, a wearable device (e.g., a wearable device 101 of FIG. 1, a wearable device 1000 of FIG. 10A and/or 10B) may comprise at least one display (e.g., a display 110 of FIG. 2A), at least one sensor (e.g., a sensor 220 of FIG. 2A), at least one processor (e.g., a processor 210 of FIG. 2A) comprising processing circuitry, and memory (e.g., memory 215 of FIG. 2A) comprising one or more storage mediums, storing instructions. The instructions, when executed by the at least one processor individually and/or collectively, may cause the wearable device to display an image in the entire display area of the at least one display according to the first frame rate while identifying the movement speed of the gaze position higher than the first reference speed (e.g., a first reference speed vth1 of FIG. 5) through the at least one sensor. The instructions, when executed by the at least one processor individually and/or collectively, may cause the wearable device to display an image in a foveated portion of the display area according to a second frame rate lower than the first frame rate, and display an image in a peripheral portion of the display area, while identifying the movement speed of the gaze position lower than the first reference speed and higher than the second reference speed (e.g., a second reference speed vth2 of FIG. 5) through the at least one sensor. The instructions, when executed by the at least one processor individually and/or collectively, may cause the wearable device to display an image in the foveated portion according to a third frame rate lower than the second frame rate, and display an image in the peripheral portion according to the second frame rate, while identifying the movement speed of the gaze position lower than the second reference speed through the at least one sensor. According to an embodiment of the disclosure, the wearable device may reduce and/or optimize resources occupied for foveated rendering. According to an embodiment of the disclosure, the wearable device may change a frame rate for obtaining an image for the foveated rendering according to the movement speed of the gaze position.

For example, the instructions, when executed by the at least one processor individually and/or collectively, may cause the wearable device to, while identifying the movement speed of the gaze position lower than the second reference speed through the at least one sensor, display an image on the foveated portion using the second frame rate determined to update the image displayed on the foveated portion when the gaze position reaches the boundary of the foveated portion.

For example, the instructions, when executed by the at least one processor individually and/or collectively, may cause the wearable device to, when the gaze position reaches the boundary of the foveated portion, obtain an image corresponding to another portion next to the portion corresponding to the foveated portion within the image displayed in the periphery portion, as an image to be displayed in the foveated portion.

For example, the other portion may be located next to the portion corresponding to the foveated portion according to a direction in which the gaze position is moved.

For example, the instructions, when executed by the at least one processor individually and/or collectively, may cause the wearable device to, while identifying the movement speed of the gaze position lower than the second reference speed through the at least one sensor, determine the third frame rate so that the image displayed on the foveated portion is maintained while the gaze position overlaps the foveated portion.

For example, the instructions, when executed by the at least one processor individually and/or collectively, may cause the wearable device to, while identifying the movement speed of the gaze position lower than the first reference speed, change the size of the foveated portion using the movement speed.

For example, the instructions, when executed by the at least one processor individually and/or collectively, may cause the wearable device to, while displaying an image of a first resolution in the periphery portion, display an image corresponding to the portion of the image of the first resolution on the foveated portion of the display area overlapping the gaze position.

For example, the instructions, when executed by the at least one processor individually and/or collectively, may cause the wearable device to display images having a size less than the size of the entire display area, respectively, in the foveated portion and the periphery portion.

For example, the instructions, when executed by the at least one processor individually and/or collectively, may cause the wearable device to obtain the information using sensor data of the at least one sensor including the image sensor (e.g., the image sensor 130 of FIG. 2A) configured to be disposed toward the user's eyes and the motion sensor (e.g., the motion sensor 222 of FIG. 2A) configured to detect the motion of the wearable device.

As described above, in an embodiment of the disclosure, a method of a wearable device comprising at least one display and at least one sensor may be provided. The method may comprise displaying an image in the entire display area of the at least one display according to the first frame rate while identifying the movement speed of the gaze position higher than the first reference speed through the at least one sensor. The method may comprise displaying an image in a foveated portion of the display area according to a second frame rate lower than the first frame rate, and displaying an image in a peripheral portion of the display area, while identifying the movement speed of the gaze position lower than the first reference speed and higher than the second reference speed through the at least one sensor. The method may comprise displaying an image in the foveated portion according to a third frame rate lower than the second frame rate, and displaying an image in the peripheral portion according to the second frame rate, while identifying the movement speed of the gaze position lower than the second reference speed through the at least one sensor.

For example, the displaying according to the second frame rate may comprise, while identifying the movement speed of the gaze position lower than the second reference speed through the at least one sensor, displaying an image on the foveated portion using the second frame rate determined to update the image displayed on the foveated portion when the gaze position reaches the boundary of the foveated portion.

For example, the displaying according to the second frame rate may comprise, when the gaze position reaches the boundary of the foveated portion, obtaining an image corresponding to another portion next to the portion corresponding to the foveated portion within the image displayed in the periphery portion, as an image to be displayed in the foveated portion.

For example, the other portion may be located next to the portion corresponding to the foveated portion according to a direction in which the gaze position is moved.

For example, the displaying according to the third frame rate may comprise, while identifying the movement speed of the gaze position lower than the second reference speed through the at least one sensor, determining the third frame rate so that the image displayed on the foveated portion is maintained while the gaze position overlaps the foveated portion.

For example, the method may comprise, while identifying the movement speed of the gaze position lower than the first reference speed, changing the size of the foveated portion using the movement speed.

For example, the method may comprise, while displaying an image of a first resolution in the periphery portion, displaying an image corresponding to the portion of the image of the first resolution on the foveated portion of the display area overlapping the gaze position.

For example, the method may comprise displaying images having a size less than the size of the entire display area, respectively, in the foveated portion and the periphery portion.

For example, the method may comprise obtaining the movement speed using sensor data of the at least one sensor including the image sensor configured to be disposed toward the user's eyes and the motion sensor configured to detect the motion of the wearable device.

As described above, in an embodiment of the disclosure, a non-transitory computer readable storage medium comprising instructions may be provided. The instructions, when executed by a wearable device comprising a display system including a first display and a second display which are configured to be positioned toward each of eyes of a user wearing the wearable device and at least one sensor, may cause the wearable device to, while identifying a movement speed of a gaze position higher than a reference speed through the at least one sensor, control the display system to respectively display images obtained according to a first frame rate in foveated portion and a periphery portion. The instructions, when executed by a wearable device, may cause the wearable device to, while identifying a movement speed of the gaze position lower than the reference speed through the at least one sensor, control the display system such that an image obtained according to the first frame rate is displayed in the periphery portion and an image obtained according to a second frame rate lower than the first frame rate is displayed in the foveated portion.

For example, the instructions, when executed by the wearable device, may cause the wearable device to generate a composite image to be displayed through the display system by combining, to each images obtained according to the first frame rate, an image which was obtained according to the second frame rate.

For example, the instructions, when executed by the wearable device, may cause the wearable device to, while identifying the movement speed of the gaze position higher than another reference speed exceeding the reference speed, control the display system such that an image obtained according to the first frame rate is displayed based on a size of display area of the display system.

As described above, according to an embodiment of the disclosure, a wearable device (e.g., the wearable device 101 of FIG. 1, the wearable device 1000 of FIG. 10A and/or 10B) may comprise a display system including a first display and a second display which are configured to be positioned toward each of eyes of a user wearing the wearable device, at least one sensor (e.g., the sensor 220 of FIG. 2A), at least one processor (e.g., the processor 210 of FIG. 2A) comprising processing circuitry, and memory (e.g., the memory 215 of FIG. 2A), comprising one or more storage mediums, storing instructions. The instructions, when executed by the at least one processor individually and/or collectively, may cause the wearable device to, while identifying a movement speed of a gaze position higher than a reference speed through the at least one sensor, control the display system to respectively display images obtained according to a first frame rate in foveated portion and a periphery portion. The instructions, when executed by the at least one processor individually and/or collectively, may cause the wearable device to, while identifying a movement speed of the gaze position lower than the reference speed through the at least one sensor, control the display system such that an image obtained according to the first frame rate is displayed in the periphery portion and an image obtained according to a second frame rate lower than the first frame rate is displayed in the foveated portion.

For example, the instructions, when executed by the wearable device comprising at least one display and at least one sensor, may cause the wearable device to generate a composite image to be displayed through the display system by combining, to each images obtained according to the first frame rate, an image which was obtained according to the second frame rate.

For example, the instructions, when executed by the wearable device comprising at least one display and at least one sensor, may cause the wearable device to, while identifying the movement speed of the gaze position higher than another reference speed exceeding the reference speed, control the display system such that an image obtained according to the first frame rate is displayed based on a size of display area of the display system.

As used herein, the term “if” will be understood to mean “˜when, upon” “in response to determining,” or “in response to detecting,” depending on the context. Similarly, “in case that it is determined that˜” or “in case that [the mentioned condition or event] is detected” will optionally be understood to mean “when determining,” “in response to determining,” “when detecting [the mentioned condition or event], or “in response to detecting [the mentioned condition or event]”.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include may be those configured to store program instructions, including a magnetic medium, such as a hard disk, floppy disk, and magnetic tape, optical recording medium, such as compact disc (CD)-ROM and digital versatile disc (DVD), magneto-optical medium, such as floptical disk, and ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the scope of the disclosure as defined by the appended claims and their equivalents.

No claim element is to be construed under the provisions of 35 U.S.C. § 112, sixth paragraph, unless the element is expressly recited using the phrase “means for” or “means.”

What is claimed is:

1. A wearable device comprising:
a display system including a first display and a second display which are configured to be respectively positioned toward eyes of a user wearing the wearable device;
at least one sensor;
memory storing one or more computer programs; and
one or more processors communicatively coupled to the display, the at least one sensor, and the memory,
wherein the one or more computer programs include computer-executable instructions that, when executed by the one or more processors individually or collectively, cause the wearable device to:
obtain information with respect to a gaze position by using the at least one sensor, and
based on identifying a movement speed of the gaze position slower than a reference speed using the information:
obtain a plurality of first images corresponding to a display area of the display system,
obtain a second image corresponding to a foveated area that is specified within the display area based on the gaze position, and
perform foveated rendering with respect to a screen to be displayed through the display area by combining the second image to each of the plurality of first images that is upscaled based on a size of the display area.

2. The wearable device of claim 1,
wherein the reference speed is a first reference speed, and
wherein the one or more computer programs further include computer-executable instructions that, when executed by the one or more processors individually or collectively, cause the wearable device to:
based on identifying that a movement speed of the gaze position that is faster than the first reference speed and slower than a second reference speed higher than the first reference speed:
identify whether the movement speed and a movement direction of the gaze position are maintained,
based on identifying that the movement speed and the movement direction are maintained, determine a frame rate corresponding to the movement speed and being included in a range lower than a reference frame rate of the display system,
obtain the plurality of first images corresponding to the display area of the display system according to the frame rate,
obtain a plurality of third images corresponding to the foveated area according to the frame rate,
combine, to each of the plurality of first images that is upscaled based on a size of the display area, each of the plurality of third images, and
perform foveated rendering with respect to the screen to be displayed through the display area by performing extrapolation of combinations of the plurality of first images and the plurality of third images according to a difference between the reference frame rate and the frame rate.

3. The wearable device of claim 2, wherein the one or more computer programs further include computer-executable instructions that, when executed by the one or more processors individually or collectively, cause the wearable device to:
obtain the plurality of third images which are arranged along the movement direction within the display area.

4. The wearable device of claim 2, wherein the one or more computer programs further include computer-executable instructions that, when executed by the one or more processors individually or collectively, cause the wearable device to:
determine the frame rate such that, while the gaze position overlap the foveated area corresponding to a fourth image of the plurality of third images, the foveated rendering based on the fourth image corresponding to the foveated area is performed.

5. The wearable device of claim 2, wherein the one or more computer programs further include computer-executable instructions that, when executed by the one or more processors individually or collectively, cause the wearable device to:
based on identifying the movement speed of the gaze position faster than the first reference speed and slower than the second reference speed, determine sizes of the plurality of third images according to the movement speed.

6. The wearable device of claim 2, wherein the one or more computer programs further include computer-executable instructions that, when executed by the one or more processors individually or collectively, cause the wearable device to:
based on identifying changing of at least one of the movement speed or the movement direction, obtain the plurality of first images and the plurality of third images according to the reference frame rate among the frame rate and the reference frame rate.

7. The wearable device of claim 1,
wherein the reference speed is a first reference speed, and
wherein the one or more computer programs further include computer-executable instructions that, when executed by the one or more processors individually or collectively, cause the wearable device to:
based on identifying the movement speed of the gaze position faster than a second reference speed higher than the first reference speed:
obtain the plurality of first images corresponding to the display area of the display system, and
perform the foveated rendering with respect to the screen using the plurality of first images upscaled based on the size of the display area such that portions of the plurality of first images are located at the foveated area.

8. The wearable device of claim 1, wherein the one or more computer programs further include computer-executable instructions that, when executed by the one or more processors individually or collectively, cause the wearable device to:
obtain the plurality of first images having sizes smaller than a size of the entire display area.

9. The wearable device of claim 1, wherein the one or more computer programs further include computer-executable instructions that, when executed by the one or more processors individually or collectively, cause the wearable device to:
obtain the information using sensor data of the at least one sensor comprising:
an image sensor configured to be positioned toward an eye of a user, and
a motion sensor configured to detect motion of the wearable device.

10. The wearable device of claim 1, wherein the one or more computer programs further include computer-executable instructions that, when executed by the one or more processors individually or collectively, cause the wearable device to:
update the second image to be used for the foveated rendering based on identifying that the gaze position overlaps a portion of the display area corresponding to a boundary of the second image.

11. A method of a wearable device comprising a display system including a first display and a second display which are configured to be respectively positioned toward eyes of a user wearing the wearable device and at least one sensor, the method comprising:
obtaining information with respect to a gaze position by using the at least one sensor; and
based on identifying a movement speed of the gaze position slower than a reference speed using the information:
obtaining a plurality of first images corresponding to a display area of the display system,
obtaining a second image corresponding to a foveated area that is specified within the display area based on the gaze position, and
performing foveated rendering with respect to a screen to be displayed through the display area by combining the second image to each of the plurality of first images that is upscaled based on a size of the display area.

12. The method of claim 11,
wherein the reference speed is a first reference speed, and
wherein the method further comprising:
based on identifying that a movement speed of the gaze position faster than the first reference speed and slower than a second reference speed higher than the first reference speed:
identifying whether the movement speed and a movement direction of the gaze position are maintained,
based on identifying that the movement speed and the movement direction are maintained, determining a frame rate corresponding to the movement speed and being included in a range lower than a reference frame rate of the display system,
obtaining the plurality of first images corresponding to the display area of the display system according to the frame rate,
obtaining a plurality of third images corresponding to the foveated area according to the frame rate,
combining, to each of the plurality of first images that is upscaled based on a size of the display area, each of the plurality of third images, and
performing foveated rendering with respect to the screen to be displayed through the display area by performing extrapolation of combinations of the plurality of first images and the plurality of third images according to a difference between the reference frame rate and the frame rate.

13. The method of claim 12, wherein the obtaining of the plurality of third images comprises:
obtaining the plurality of third images which are arranged along the movement direction within the display area.

14. The method of claim 12, wherein the determining of the frame rate comprising:
determining the frame rate such that, while the gaze position overlap the foveated area corresponding to a fourth image of the plurality of third images, the foveated rendering based on the fourth image corresponding to the foveated area is performed.

15. The method of claim 12, further comprising:
based on identifying the movement speed of the gaze position faster than the first reference speed and slower than the second reference speed, determining sizes of the plurality of third images according to the movement speed.

16. The method of claim 12, wherein the obtaining of the plurality of third images comprising:
based on identifying changing of at least one of the movement speed or the movement direction, obtaining the plurality of first images and the plurality of third images according to the reference frame rate among the frame rate and the reference frame rate.

17. The method of claim 11,
wherein the reference speed is a first reference speed, and
wherein the method further comprising:
based on identifying the movement speed of the gaze position faster than a second reference speed higher than the first reference speed:
obtaining the plurality of first images corresponding to the display area of the display system, and
performing the foveated rendering with respect to the screen using the plurality of first images upscaled based on the size of the display area such that portions of the plurality of first images are located at the foveated area.

18. The method of claim 11, wherein the obtaining of the plurality of first images comprising:
obtaining the plurality of first images having sizes smaller than a size of the entire display area.

19. One or more non-transitory computer readable storage media storing computer-executable instructions that, when executed by one or more processors individually or collectively of a wearable device comprising a display system including a first display and a second display which are configured to be positioned toward eyes of a user wearing the wearable device and at least one sensor, cause the wearable device to perform operations, the operations comprising:
while identifying a movement speed of a gaze position higher than a reference speed through the at least one sensor, controlling the display system to respectively display images obtained according to a first frame rate in foveated portion and a periphery portion; and
while identifying a movement speed of the gaze position lower than the reference speed through the at least one sensor, controlling the display system such that an image obtained according to the first frame rate is displayed in the periphery portion and an image obtained according to a second frame rate lower than the first frame rate is displayed in the foveated portion.

20. The one or more non-transitory computer readable storage media of claim 19, the operations further comprising:
generating composite images to be displayed through the display system by combining, to each images obtained according to the first frame rate, an image which was obtained according to the second frame rate.
